(19) United States
(12) Patent Application Publication
(10) Pub. No.: US 2010/0198755 A1
(43) Pub. Date: Aug. 5, 2010

(54) ENHANCED MEDICAL TREATMENT

(76) Inventors: Andrew H. Soll, Pacific Palisades, CA (US); Liana Violet Soll, Venice, CA (US)

Correspondence Address: Troutman Sanders LLP, The Chrysler Building, 405 Lexington Avenue, New York, NY, 10174, US

(21) Appl. No.: 12/563,942

(22) Filed: Feb. 5, 2010

Related U.S. Application Data
(63) Continuation-in-part of application No. 09/289,044, filed on Apr. 9, 1999, now Pat. No. 7,593,952.

(51) Int. Cl. G06F 17/21

(52) U.S. Cl. 706/11

(57) ABSTRACT

This invention deals with an enhanced medical treatment system which seeks input from the patient and the physician about the medical problems faced by the patient. It analyzes this information and seeks to guide physicians to a correct diagnosis of the complaint. It also seeks to educate the patient about his/her medical problems and provides information about the problem. It is able to store all this information, so that a continuous record of the patient's visits and problems is kept on file and the physician is able to utilize the medical history to solve the patient's current problems. With this system in place the medical establishment will be able to improve health care delivery to the patients and be able to better manage the process of the providing health care. Furthermore, this system will also lower the cost of providing health care without compromising on the quality of health care.

### PRIORITY INFORMATION

This application is a continuation-in-part of U.S. patent application Ser. No. 09/289,044, filed on Apr. 4, 1999.

### FIELD OF THE INVENTION

The present invention relates to systems for disease management, and more specifically to a practical computer system and clinical management methodology that enhances the quality and cost-effectiveness of health care in real practice settings. The approach is to integrate a plurality of separate functions into a seamless diagnostic and treatment system that enhances patient assessment, activates (primes) and educates patients to become maximally involved in their care, and improves the efficiency of clinician management process (Table 1). The system will simultaneously enhance health care delivery and capture data regarding the process and outcomes of care, thereby allowing the quality and efficiency of specific treatments or of an overall management process to be measured and improved.

TABLE 1
Goals and Functions of the Invention

| | |
|---|---|
| 1. | Directly collect, analyze, and verify comprehensive, accurate patient data to facilitate and |
| | improve patient evaluation |
| 2. | Use a patient-friendly, intuitive interface that allows: |
| | direct patient input of data |
| | simplification of computer use (e.g. touch screens) |
| | use of screening questions that branch to detailed questions only where relevant to patient's |
| | complaints or situation |
| | individualized strategy for computerized patient interaction (adapts to patient characteristics, |
| | e.g., age, gender, language, education level) |
| 3. | Create a computer system that facilitates patient-centered care at multiple levels: |
| | facilitate communication between patients and clinicians |
| | guide and educate patients on symptoms and health issues |
| | “activate” (prime) patients to provide a more accurate, comprehensive history and to be |
| | more involved in their care |
| | collect and present the patient's health questions and concerns to clinicians |
| | collect and present comprehensive biopsychosocial data to clinicians |
| | assess patient response to and satisfaction with care |
| 4. | Improve the efficiency and effectiveness of clinician process: |
| | provide a clinician-friendly, easy-to-use computer system |
| | present patient data with summaries of scores and other data for rapid review |
| | present alerts to identify and flag problems of potentially critical importance |
| | present patient data in a problem-oriented format for efficient review and editing |
| | expedite generation of the clinical report for the documentation |
| | facilitate generation of orders for tests, medications, procedures or referrals |
| | in follow-up mode, improve clinician access to prior patient records using a concise, |
| | problem-oriented format |
| 5. | Improve the outcomes and cost-effectiveness of care |
| 6. | Build comprehensive process and outcome database to: |
| | capture the clinical presentation of common disorders, thereby improving diagnostic |
| | accuracy and efficiency |
| | assess the value of various therapeutic interventions |
| | assess the value of various elements of patient-centered care (see 3 above) |
| | support rigorous clinical investigation in real practice settings to measure and improve the |
| | outcomes of care |

### BACKGROUND OF THE INVENTION

Implementing Health Care Advances in Practice Settings. Recent technological advances have engulfed the health care field, but have not generally resulted in improved health care for many common conditions. The sophistication of diagnostic tools has increased ten-fold in the last two decades, including such exotic technologies as nuclear magnetic resonance imaging to detect the spin state of individual protons within a patient's body for characterizing select structures and disturbances within key organs. Other advances include genetically engineered antigen labels for accurately identifying destructive organisms, and precisely configured synthetic analogues of metabolic agents with high specificity for triggering select defensive responses.

These technologies will continue to grow exponentially as health care becomes increasingly important to a relatively wealthy, but rapidly aging society. Indeed, a significant barrier to advances in health care is their cost, which continues to grow faster than the general inflation rate. Additionally, knowledge of how to apply available advances in real practice settings is limited. Despite dramatic technological advances in many areas, hundreds of billions of dollars are wasted annually and patients suffer poor outcomes because physician deliver inappropriate care as a result of not having an adequate biomedical, psychosocial, and behavioral assessment at the outset of care. Patient dissatisfaction with conventional medical management has fueled huge expenditures of personal health dollars for alternative care, much of which remains of uncertain benefit and risk.

Inadequate clinician time for optimal patient care. Health care costs have risen steeply and, with clinician time a valuable commodity, few clinicians can spend more than a fraction of an hour—even with new patients. In the past, a patient's expectations were largely inspired by the image of a house-calling clinician who devoted hours of personal “bedside” attention to every patient, a model seldom found today. In many environments clinician time is so limited as to preclude a comprehensive evaluation. Inattention to detail or inadequate assessment of the patient's overall biopsychosocial situation generates inefficiencies of care.

We use the term clinician to refer to any health professional who interacts with patients and cares for some aspect of the patient's health, including physicians, nurse practitioners, physician's assistants, psychologists, social workers, physical therapists, nurses, and other individuals who may access or enter health information on the patient.

Complex cases often with medically-unexplained symptoms. The absence of clinician time, especially with patients they do not know well, is particularly unfortunate because the large majority of physical symptoms that patients report in both primary and subspecialty care settings end up being medically unexplained, in that no underlying organic cause can be found{Reid, 2001 REID2001/id}. Disorders with medically-unexplained symptoms include irritable bowel syndrome, fibromyalgia, chronic fatigue, and many forms of chronic pain, to name a few. Medically-unexplained symptoms by definition do not lead to disease outcomes that will shorten the patient's life or lead to serious illness. The only exception is that suicidality is common in patients who become hopeless about improvements in their chronic pain or other conditions.

Importantly, medically-unexplained symptoms are concentrated in subset of complex cases, which comprise about 20% of typical clinic populations. Complex cases usually have multiple, often severe physical symptoms. It appears that pain or sensory dysregulation, an abnormality in the brain's pain regulatory pathways, contributes to this multiplicity and severity of physical symptoms. Patients with medically-unexplained symptoms, especially when numerous or severe in complex cases, have impaired quality of life, poor ability to function, and frequent disability. Superimposed psychosocial issues are common in complex cases. These cases are difficult to manage, have poor outcomes, and consume a disproportionate slice of the health care dollar. Barsky et al estimated the costs for the care of complex cases in two Harvard affiliated practices; extrapolating their data to a national level, an estimated $256 billion was spent on the inappropriate care of such cases in 2002 {Barsky, 2005 BARSKY2005/id}. However, this figure is an underestimate. A proportion of patients with organic disease, such as diabetes or rheumatoid arthritis, also have the same pain dysregulation and psychosocial issues that characterize complex cases with medically-unexplained symptoms. These complex patients with organic disease have symptoms that are disproportionate to the severity of organic disease, complicating management and increasing costs. Furthermore, complex cases receive risky care, such as inappropriate surgery. The overall costs may well exceed $500 billion annually, making this a very large, but correctable problem in healthcare delivery.

The challenge of patient assessment: medically-unexplained symptoms and factors that influence symptom reporting. The clinical challenge is to appropriately recognize patients with medically-unexplained symptoms and discriminate them from less common cases of organic disease underlying symptoms that require specific therapy. One barrier to efficient clinical evaluation is that the symptom patterns of organic disease and functional disorders are surprisingly nonspecific; for most visceral disorders, there is only a weak correlation between a given symptom complex and underlying organic disease. For example, only 10 to 20% of patients with classic “peptic ulcer” symptoms have ulcers and many patients with ulcers are asymptomatic or present with other than classic symptoms {Soli, 2005 SOLL2005A/id}. Furthermore, with multiple symptoms, the patterns overlap and overlapping symptoms confound the diagnostic process, raising both patient and clinician anxiety about missing any underlying organic disease.

Patients must be primed to understand the features of their symptoms and essential medical terms so that they can provide a diagnostically-relevant history. The rapid-fire questions of a rushed clinician interview do not allow time for most patients to understand the issues and think through their answers. When patients are rushed or feel as if they are not listened to, anxiety mounts and the outcomes of care deteriorate.

Extracting a history from patients, especially in the face of multiple, overlapping symptoms, requires diligence, skill at pattern recognition, and time. However, conventional wisdom assumes that the non-specificity and overlap of symptoms obviates benefit from a detailed history. In addition, the process of unraveling an adequate history takes time and the expectation that the process will yield valuable clinical information. Furthermore, the onslaught of technology has displaced history taking and symptom pattern recognition, rendering these skills underutilized and unrefined for most clinicians. For these reasons, an adequate history is rarely obtained. When clinicians are not clear on symptom presentation and basic pattern recognition, they are driven to perform more tests, use more medications, or refer patients for consultations, procedures, or even surgery. Accordingly, costs escalate and the efficiencies of care are lost.

Physician information overload. Sophisticated new technologies provide a volume and complexity of diagnostic information that can easily overwhelm practicing clinicians. Few clinicians can effectively manage and utilize the spectrum of advanced equipment, space age therapeutic regimens, and the massive amount of information that goes with them. Ironically, health care providers are also overwhelmed with the process of handling medical records for patients. Paper charts are outmoded, especially in environments where several clinicians are involved in care and where there is rarely the time to carefully read complex and often poorly organized charts. Sophisticated electronic medical record systems (EMRs) have been developed to handle laboratory records and other patient information. However, available EMR systems do not (1) collect and process information from patients, (2) transmit patient data to clinicians, or (3) manage historical data regarding the clinician-patient interaction (patient history, clinician assessment, follow-up data) in a dynamic, efficient manner. With EMRs, clinicians often copy and paste prior notes, further diluting the impact of the process. The inadequacies of current patient data management systems disrupt the process of care.

Patient information overload and lack of self-care. Like clinicians, patients encounter information overload. Typically, a patient is provided with information regarding their problems and possible treatments in technical jargon that leaves them bewildered and intimidated. The information that should clarify the nature of their problem becomes an almost insurmountable barrier to understanding. In addition to being incomprehensible, health instructions and treatment plans may also be impractical for an individual patient's lifestyle, and thus will not encourage compliance. Thus, the patient becomes alienated from their potential role in the care process, leading to a poor response to treatment.

Failure to capitalize on patient-centered care. Although patient outcomes and the efficiency of care will be improved by an integrated approach to the whole patient and the clinician-patient interaction, conventional medicine perseveres in its biomedical focus on disease, tests and medications. Notwithstanding rapid technological advances in medicine, the patient's initial psychological status and response to the therapeutic process plays a substantial role in the overall success of treatment. The highly variable, but well-documented “placebo response” reflects the inherent role of patient health attitudes and the quality of the clinician-patient interaction on the patient's response to therapy. The potential benefits of patient-centered elements of the care process (Table 1) are evident, but they are difficult to implement in most busy, resource-limited practice settings {Stewart, 1995 STEWART1995/id}.

Controlling costs while preserving quality of care. As health care costs have skyrocketed, many cost-saving solutions have been explored in the health care marketplace. In some situations, per capita costs have been cut to preserve profits, jeopardizing health outcomes and the quality of care. The challenge is to ensure that the quality of and access to care are maintained and improved, while costs are contained. Health care managers must make difficult decisions when attempting to control costs while preserving the quality of care. There is great potential for waste through misapplication of care on one hand, or under-utilization of indicated treatments on the other.

The process and outcome data needed for cost-saving, quality-preserving decisions. Disease management guidelines have been developed in an attempt to standardize care and control costs. However, methods are not available to appropriately test, implement, and monitor specific disease management guidelines that have been developed in an effort to control costs while maintaining the quality of care. Decisions regarding allocation of health care resources generally rely on available data for treatment efficacy in study populations. However, these efficacy data often fail to predict the treatment effectiveness in real practice settings. The information needed to make decisions regarding health care utilization are data from real practice settings on patient outcomes (how the patient felt and functioned before and after treatment), the process of care (what the clinician did and thought), and the costs. Health care providers do not have the time to verbally gather or record process and outcome data. Paper questionnaires are also an impractical and inefficient means to gather high quality data. Computer systems, and Web resources in particular, offer great promise for gathering patient assessment and outcome data, but have not yet been adequately developed to warrant utilization in routine care. Therefore, the health care delivery system currently lacks the tools to measure the impact of treatment on the outcomes and quality of care. Practical systems are needed to routinely perform these essential measurement tasks.

The predicate for the present invention is informed by the problems inherent in the current health care delivery infrastructure cited above. It is with recognition of these problems in the state of the art that the present invention provides the following objects.

### OBJECTS OF THE PRESENT INVENTION

The ecumenical object of the invention is to develop an integrated computer system that supports a new paradigm of health care delivery. The system, referred to herein as CarePrep, will accomplish this goal by integrating biomedical and psychosocial approaches to patient management and providing tools to improve and measure patient assessment, quality of life, and clinician process. These approaches and tools will provide a means to support the delivery of high quality health care at lower overall costs. The targeted domains cover the spectrum of topic areas that are important to the patient or relevant to patient management decisions or to predicting and measuring the patient response over time. These targeted domains include topics the patient's presenting physical and emotional symptoms (complaints) and a range of psychosocial issues (such as depression, anxiety, panic, suicidal ideation, phobias, poorly-tolerated stress, post-traumatic stress disorder, a somatization tendency for reporting severe physical symptoms, and bipolar disorder; and personality traits (such as catastrophyzing or neuroticism). Other targeted domains also include various dimensions of the patient's quality and enjoyment of life and functional status, the latter referring to the ability to do what patients need or want to do, their attitudes toward their health or lack-thereof and behaviors relevant to health issues.

The specific objects are:
to provide a computer system (the patient module) to improve the effectiveness of patient assessment by collecting standardized, comprehensive data during an interactive patient assessment session. CarePrep efficiently and accurately collects patient information across the various targeted domains, and identifies provisional problems. The system also assesses and tracks patient outcomes, which are the patient's symptoms, quality of life, and functional status between initial and follow-up evaluations.
to provide a clinician module accessible over the Internet or a local network to present current and past patient-entered data and clinician-entered data in a problem-oriented fashion, so that data about a problem (specific symptom, psychosocial and behavioral factors issue or condition) can be readily accessed and reviewed, thereby facilitating the clinician process of care and simultaneously capturing measures of clinician process in the database.
to provide a system that is user-friendly for both patients and clinicians so that the system is practical for installation in routine inpatient or outpatient care settings.
to provide a system that implements and monitors the quality, consistency, and effectiveness of patient-centered care in practice settings.
to provide integrated measures of patient outcomes and clinician process that can be utilized to investigate the success of specific treatments or overall management strategies.
to provide a server/database for dynamic, problem-oriented archiving of the data collected by CarePrep and efficient access to that problem-oriented information.
to provide a patient management system that is flexible, thereby allowing continued refinement and extension in assessment and treatment strategies to cover the full spectrum of medical, psychiatric, surgical, and pediatric disciplines (Table 2).

TABLE 2
Initial Modules for Screening and Characterization of Specific
Conditions (partial list)

Gastroenterology
Cardiovascular medicine
Pulmonary medicine (chronic lung disease, emphysema, asthma)
Infectious disease
Allergy
Rheumatology/Orthopedics/Rehab Medicine (joint, back and connective
tissue conditions)
Renal disorders (hypertension)
Endocrine disorders (diabetes, thyroid conditions, obesity)
Male genitourinary: Urology (prostate conditions)
Female disorders: Gynecology (dysmenorrhea, female conditions)
General Internal Medicine (general health status, preventive medicine,
functioning in activities of daily living)
Neurology (headaches, strokes, epilepsy, movement)
Psychology (psychologic conditions and stress)
All surgical specialties
Pediatrics
Social work, disability assessment, and other related clinical areas
Physical therapy or rehabilitation assessment and management
Alternative, holistic, or complementary clinical management

### BRIEF DESCRIPTION OF THE DRAWINGS

FIG. 1 is a hardware block diagram of the salient components of the present invention.

FIG. 2 is the hardware configuration of the patient carrel.

FIG. 3 is a flow chart for the CPMS-implemented CAPM, showing how the information flows through the various components of the invention.

FIG. 4A is a flow chart of the patient sign in and nurse assessment program.

FIG. 4B is a flow chart of the program run on the nurse's module.

FIG. 5A is a flow chart of the program run on the patient carrel.

FIG. 5B is a flow chart run of the program run on the general screening module.

FIG. 5C is a flow chart of the education module relevant to the upcoming topic.

FIG. 5D is an example of the questions and answers asked.

FIG. 6A is a flow chart of the program relating to the screening questions; “review of systems” that are given to the patient to answer.

FIG. 6B is a flow chart of the program that screens for cardiovascular disease.

FIG. 6C is a flow chart of the program that screens for acid reflux and chest pain.

FIG. 6D is a flow chart of the program that screens for respiratory conditions & GER complications.

FIG. 6E is a flow chart of the program that screens for dysphagia.

FIG. 6F is a flow chart of the program that screens for abdominal pain, indigestion & acid dyspepsia.

FIG. 6G is a flow chart of the program that assesses constipation, diarrhea and irritable bowel syndrome.

FIG. 7A is a flow chart of the program for general strategy for symptom characterization.

FIG. 7B is a flow chart of the program for general strategy for symptom characterization.

FIG. 7C is a flow chart of the program that helps in the detection of obscured symptom complexes.

FIG. 8 is a flow chart of the program for sorting out multiple problems.

FIG. 9A is a flow chart of the program for psycho-social assessment.

FIG. 9B is a flow chart of another program for psycho-social assessment.

FIG. 10 is a flow chart of a program for general health status.

FIG. 11A is a flow chart of a program for patient assessment functions at the physician module.

FIG. 11B is a flow chart of a program for physician management and reporting process.

FIG. 12 is a flow chart of a program for functions and flow during exit session at the patient module.

FIG. 13 is a flow chart of a program for functions and flow of the patient module during revisits by the patient.

### SUMMARY OF THE INVENTION

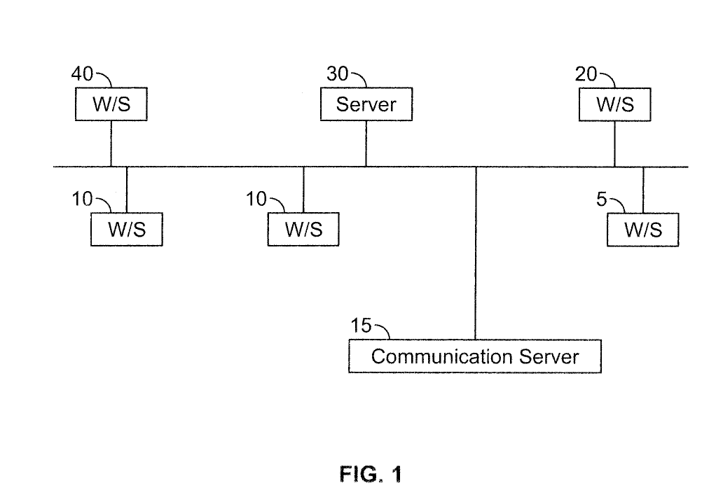

Overview of the CarePrep system. The computerized CarePrep system provides a practical means to implement, integrate, and measure biomedical and psychosocial dimensions of comprehensive patient management in real practice settings. This integration is embodied in the basic components of the invention, namely a patient module, a clinician module, and a server/database (FIG. 1). The overall goal of the invention is to maximize quality while controlling health care costs. This goal can only be achieved when the background problems raised above are addressed.

Patients interact with the inventive system during initial assessment that may span one or more sessions, at exit sessions, and at revisits sessions. Patients (or family or caretakers) directly input data into the patient module, a user-friendly, interactive computer system that systematically records and analyzes relevant information about the patient's health. These structured, comprehensive data are then processed and reported to clinicians in a problem-oriented format to facilitate patient assessment and diagnostic decision-making. Summaries are included to facilitate rapid review. Potentially critical findings are flagged in an Alert section. Physician process is aided by expert medical assessment and treatment strategies that are optionally embedded in the inventive system. The clinician edits the report and adds assessment and management plans, which are then generated as the final clinical report. Finally, the clinician may also select patient educational materials, which are given to the patient along with a health summary at the exit session. CarePrep “remembers” patients upon return and updates their symptom profiles accordingly. The system saves time and improves efficiency for both patients and clinicians by focusing the health care encounter on active problems. Changes in patient quality of life and response to and satisfaction with care, captured in the server/database, can be related to specific treatments and the overall management process.

Ultimately, methods of the inventive system facilitate high quality, cost-effective patient care by supporting clinical investigation of specific treatments; testing, implementation, and monitoring of management guidelines; and integrated quality of care assessment and improvement. The goal of system development is to use a computerized system to embody the process of a master clinician in patient assessment and clinician management. Computerization of this process requires ongoing refinement as this system is extended to cover a wide range of medical and psychiatric disorders.

Accurate, thorough patient assessment. The first component of the invention is the Web- or network-based patient module, which is designed to increase the effectiveness of patient management by accurately assessing the patient's presenting health problems. A fundamental concept underlying the development of the invention is that collecting accurate, comprehensive patient data enhances the efficiency and effectiveness of patient assessment, thereby improving patient outcomes and ultimately providing data to guide appropriate utilization of health care resources. A structured, computer-assisted assessment with branching capabilities is used to present an intelligent and relevant sequence of questions to patients and collect standardized data. The structure of CarePrep permits direct entry of input data by a patient at dedicated CarePrep patient carrel or any other computer or device capable of displaying a browser over the Internet, such as a desktop, tablet, notebook, netbook or other computer, PDA, or mobile phone. These data are then analyzed in real time implementing logic based upon expert-determined criteria for identifying symptom complexes and provisional problems. Using this mechanism, the system can discern multiple and overlapping problems.

Relevance. It is essential to keep the assessment relevant to the patient because relevance is more important than length; patients will do a longer assessment if it's all about them and their health problems. Relevance is achieved through several mechanisms. First, triage questions are asked to highlight areas of immediate concern to the patient. Second, screening questions are asked to probe domains or groups of domains to ascertain relevance for the patient. Branching algorithms focus further questioning on relevant domains. Third, patients are asked to assign a priority to various domains, so that subsequent questioning can be focused on their high priority issues. In addition, to maximize patient involvement and relevance, interactions with the system are individualized based on prior patient responses and patient characteristics (e.g., age, gender, ethnicity, or socioeconomic background).

Patient-friendly interface and communication strategy. The most important feature for patient-friendly performance is presenting patients with simple, straightforward, one dimensional questions. In addition to presenting questions that patients can understand, it is essential to offer options that cover the range of possible responses so that patients are not frustrated by having to choose among inaccurate or incomplete responses. As detailed subsequently, strategies are also implemented to minimize patient confusion by clarifying any potential relationship among multiple symptoms. These features increase the accuracy of the data collected by ensuring that the patient is neither confused by the questions nor limited by inadequate response options.

A simple, interactive graphic interface directly gathers data from patients and implements patient-friendly performance that is rewarding, fun, and intuitive—even for computer-naïve patients. Multimedia elements (e.g., images, sound, video clips, and animation) are used to present questions and educational material and make the system more visually appealing. To ensure that the process is easily understood, patients are frequently given feedback or instructions based on their answers. Specific patient responses are used to construct grammatical phrases or complete sentences of concatenated text strings. This concatenated output is used to provide the feedback and instructions mentioned above and to confirm the accuracy of data and the effectiveness of communication with the patient. The optional audio system plays pre-recorded audio files on cue or uses voice synthesis to read concatenated output, which can patients listen to with headsets or speakers. Voice input can be recorded or text input received so that patient comments are captured in context. To further simplify use, exemplary patient carrels are equipped with touchscreen monitors so that use of a keyboard or mouse is not required. However, the patient module can be adapted to run on any PC-compatible, Apple, Linux, or other platform equipped with a touchscreen or a mouse or other pointing device.

Assessing the quality and consequences of the treatment process requires quantifiable endpoints. For common disorders in outpatient settings where serious outcomes (morbidity, hospitalization, surgery and death) are infrequent, the clinically-relevant endpoint is patient-reported quality of life. To this end, after provisional problems have been identified and confirmed with the patient in the assessment process, the inventive system measures condition-specific quality of life. Quality of life measurement focuses on the frequency and severity of symptoms and disruption of function and activities of daily living, and forms the basis for assessing patient outcomes. Although quality of life endpoints may appear soft, measures have been validated for both general health status and health status related to specific medical conditions. CarePrep will develop, rigorously validate, and implement reliable and practical quality of life measures, which are critical to assessing and improving the outcomes of care.

Capture and scoring relevant patient outcomes for any disorder or group of physical or emotional symptoms. Relevant patient outcomes include any of the targeted bio-psychosocial domains. Scales, which are groups of related question items that probe a given domain (topic area) are developed using standard psychometric methods. As relevant, additional questions associated with these scales ask about the severity, distress, magnitude, or strength associated with the items. A unique embodiment of the system is the use of exponential response items where an extremely severe, very severe, moderately severe, and mild are assigned scores on a power curve, such as 1000, 100, 10, and 1 respectively. This response set is useful because it allows severe symptoms to be clearly distinguished from milder symptoms so that four mild symptoms would not equal one extremely severe symptom. Severe symptoms, when subacute or chronic, are highly suggestive of enhanced symptom reporting presumably due to enhanced visceral-somatic sensation or psycho-behavioral factors that influence symptom reporting. Furthermore, symptoms have a power curve relationship with severity.

Scores calculated for these scales become the measure of severity that can be used to judge how the patient is faring over time or in response to treatment. If adequately sensitive, these quantifiable endpoints can be used to guide patient care or for research or quality assurance.

CarePrep scores will be optionally presented as a simple mean or as a raw score such as abcd/T, with a, b, c and d respectively represented the number of positive extremely severe, very severe, moderately severe, and mild symptoms in the group and T representing the total number of symptoms in the group.

The patient's positive scores for the various domains of relevance constitute an Individual Symptom Pattern (ISP) that can then be used as a baseline pattern against which to measure change. Repeated measurements over a baseline period of time or during or after treatment will allow more reliable and reproducible measurement of status. This repeated measurement will be useful for research applications of this ISP. Tracking of the ISP over time provides a unique method of determining response to time or interventions. Changes in ISP are assessed using standard statistical methods. The ISP will be presented in a detailed fashion to demonstrate trends of individual symptoms, in various levels of domain-related groupings, in global scores for physical symptoms, psychosocial issues, or quality of life, or overall well being combining all of these scores.

These various scores will be assessed initially and then monitored to detect changes in symptoms and other domains over time or in response to treatment. Patients will be sent an email, text, or phone message to remind them to logon to the CarePrep site. A link in the email or configuration setting in their CarePrep user profile will deliver them upon login to revisit Web pages that present the domains and question items positive in prior sessions, asking for status “yesterday”, over the past three days, or over the past week, thereby reducing recall bias. Patients will also be asked if they had any new symptoms or other issues to report. Therefore, the difference between prior and current scores will reveal change. In addition, change will be sought by asking whether the patient has perceived an improvement, deterioration, or no change in status.

Monitoring of status will be particularly useful for patients with condition that may deteriorate in status, complications, or side effects of potentially toxic treatments, such as cancer, inflammatory bowel disease, or rheumatoid arthritis. Patients following surgery or procedures would also be monitored with periodic questioning about status.

Patients who have used CarePrep will also be encouraged to login at their discretion to the CarePrep site to update their status and raise any questions and concerns. Concerns and questions will be explored with both structured questions (with multiple choice answers) and open text entries.

Assessing and tracking psychological problems. Traditionally, instruments that measure psychological symptoms or conditions are based on assessing symptoms or features hypothesized to be reflective of individual constructs, such as depression, anxiety, post-traumatic stress disorder (PTSD), or stress. Analyses are often categorical: Do the patient's responses reach diagnostic thresholds or not? However, in reality psychosocial issues are often an overlapping set of factors, without clear thresholds discriminating clinically relevant from irrelevant findings. Therefore, CarePrep's assessment is based on a model wherein the potential impact of psychosocial issues reflects the pattern of severity of various overlapping psychosocial components. Furthermore, interpretation of significance is potentially influenced by the number and severity of physical symptoms and quality of life and functional status or degree of disability. The various psychosocial thoughts, feelings, symptoms, or psychological distress will be dimensionally assessed, scoring the magnitude and frequency of distress in any given domain, thereby building the profile of psychosocial symptoms and issues in a given patient to comprise the psychosocial component of the ISP. The overall pattern is developed based on responses to questions assessing traditional components, such as depressed mood; general anxiety; sudden episodes of panic, anxiety, or severe physical symptoms; or phobias. Other thoughts and feelings are also screened for and assessed separately, including loss of interest in life; ability to connect with other people or isolation from others; hopeless or sense of doom; feeling guilty, worthless, like a failure, or helpless; being easily angered or startled; feeling slowed down; unable to think, concentrate, or make decisions; feeling unreal, detached from life, or losing control. Many of these thoughts and feelings occur in depression, but may also occur with anxiety states, PTSD, overwhelming stress or situational factors, illness anxiety, or other states. CarePrep uses screening questions and branching algorithms to allow these other domains to be probed in a limited number of high level screening questions.

For intensely personal conditions that may be embarrassing to communicate, such as depression, PTSD, or domestic violence, the above model of direct and indirect questioning will be applied by the system. PTSD can result from any life-threatening experience, trauma or abuse at the hands of others; when PTSD is denied in direct questioning, additional questions will probe recurring, distressing memories, flashbacks, dreams, or avoidance of circumstances reminiscent of prior experiences or events.

System scoring and interpretations will flag psychosocial issues detected in direct questions and flag apparent severity. Interpretations will also highlight other thought and feeling domains that have scores of potential relevance. The goal is to detect psychosocial issues that present somatically (generally as medically-unexplained physical symptoms or as exacerbation of symptoms related to known organic disease), that cause distress, or that disrupt the patient's functional status or quality of life. Therefore, the model for overall scoring and interpretation of psychosocial issues includes parameters for physical symptom severity and quality of life and functional status, as well as psychological distress in the domains listed above.

The detailed protocol for scoring in this clinical context will be established empirically. The optimal approach appears to be using frequency of events at the screening level, and a power curve (see Capture and scoring relevant patient outcomes for any disorder or group of physical or emotional symptoms) for distress, severity, or strength of symptoms at the detailed question item level.

Alerts for potentially critical findings. As data are being collected, alerts are being run using logic to assess patterns of response. Clinicians are consulted about appropriate criteria for Alerts. The urgency for an alert is established, depending on the potential medical importance of the symptom pattern. When criteria are met for a given alert of a given urgency, the alert fires and the actions taken depend on the urgency of the alert and the preferences selected by the clinician or the provider organization. These actions include contacting the patient's responsible clinician or clinicians by email, text messaging, paging, or other modalities. The nature of the alert will be communicated, but not the patient's identification because of security concerns, unless secure, encrypted messaging is available. Alerts are also inserted into the alert section at the top of the CarePrep report and can optionally be displayed the clinician's home page and upon accessing the home page for a given patient.

Patient exit and revisit sessions assess response to treatment process. During clinic visits, patients initially undergo the computerized CarePrep assessment and are then evaluated by a clinician. Finally, the patient optionally returns to the patient carrel for an exit session or does a follow-up at home, to receive a personalized health summary, instructions for self-care and follow-up, and educational materials. The patient's response to the clinician encounter is sought, focused on the effectiveness of communication and understanding of the clinician's diagnosis and plans for testing and treatment. When the patient returns to clinic, CarePrep operates in a revisit mode, assessing status of prior symptoms and problems, assessing compliance with medications or other recommendations, eliciting patient response to therapy and other changes in symptoms, quality of life or health status, and collecting patient questions and concerns. These exit and revisit sessions provide a unique opportunity to further understand the natural history of common medical problems and assess the patient's response to clinician process, specific treatments, or overall management strategy.

The impact of dissecting overlapping conditions on efficient patient assessment. When a patient presents with a single problem, the inventive system collects data on key symptom features (Table 3) that usually determine the general nature of the problem. When multiple problems exist, the system presents simple questions about key features to discriminate discrete symptom patterns. Without this careful history, the diagnostic process is confounded. As patients interact with the system they are primed to provide as accurate and complete data as possible.

TABLE 3
Key Features of Symptoms

Localization and referral
Quality and description
Time pattern (onset, duration, time of day, and frequency)
Precipitating factors: relation to meals, bowels, exercise, posture
Relieving factors: relief with rest, bowel movements or passing gas, or
with food, antacids or antisecretory agents
Association with a pattern of high symptom reporting
Change in any of the above

A problem-oriented approach provides the structure that the invention utilizes to unravel overlapping symptom patterns from clinical, measurement and investigational perspectives. Whereas overlap obscures symptom patterns, disaggregating a patient's symptoms by the key features allows common symptom patterns to be identified. For efficient diagnostic process, multiple, potentially overlapping problems must be discerned so that evidence of serious illness is not obscured by common functional problems (e.g., muscle aches or common functional bowel problems).

Dissecting overlap is also crucial to promptly detecting changes in symptom patterns, which can provide early evidence of new disease processes. Furthermore, for example, patients commonly get in a habit of recognizing all sensations from their chest as heartburn, and from their abdomen as gas. When something changes, the patient may associate new symptoms with these familiar problems, thereby precluding a clear history. Unless patient self-awareness is promoted and adequate time and skill are focused on dissecting these changes, important diagnostic clues may go unrecognized.

This process might seem overwhelming, but there are only a finite number of symptom groups. Furthermore, discrimination of these groups can be straightforward when the patient is appropriately educated and the process is approached methodically. During the patient assessment, the patient is educated regarding key features and overlap. Simple questions are asked about key features of symptoms elicited during screening. The invention is designed to encompass the nonspecific and overlapping nature of common symptom patterns, detect symptom groups and changes in patterns, and recognize when presenting symptoms fall outside of these common groups. The data collected facilitate discrimination of underlying organic disease from common functional patterns. This approach benefits individual patients by enhancing management. The broader public health benefits of this approach will be reaped when data on large volumes of patients are analyzed and used to refine clinical assessment strategies.

Identification and management of complex cases. Because of the poor outcomes, the burden, risks, and costs for patients, providers, and payors, rapid identification and supporting improved management of complex cases is a high priority for CarePrep functionality. As soon as key elements of the CarePrep assessment are completed by the patient, one of more of the following patterns of response are used to identify complex cases: the number and severity of physical symptoms; the presence of longstanding or past severe symptoms; clues to amplified pain processing or sensory dysregulation (such as expanded referral, cross referral, or a superimposed musculoskeletal component to the symptoms); the presence of psychosocial and behavioral factors (such as depression, anxiety, panic disorder, poorly tolerated stress, or post-traumatic stress disorder); impaired QOL and functional status; poor response to past or current treatment; high healthcare utilization; anxiety or concerns about the underlying disease, especially if no disease has been found in prior clinical testing; or dissatisfaction with care and response to treatment. A scale is used to reflect the magnitude of these various factors in a given case, thereby reflecting case complexity. The specific components and the scoring algorithm for this complex case score will be determined empirically, based upon analyzing CarePrep data in combination with utilization of health care resources and assessment by clinicians.

Clues to a musculoskeletal component include local tenderness or sensitivity to light touch in the region of the pain that reproduces the pain or reproducing the pain by coughing, movement, or tightening the muscles in the region. Amplified pain processing is also referred to as a neuropathic element of pain or symptom perception; the inventive system is designed to detect clues to a neuropathic element, which is common in complex cases.

The inventive system will be used to improve the targeting of care to patient needs and the utilization of clinic resources. The thesis is that identification of complex cases as early in the process of care as possible will reduce utilization of resources consumed for inappropriate care of largely medically-unexplained symptoms. The same approach will be relevant for patients with organic disease; finding these same features as seen in complex case without organic disease is likely to predict the presence of symptoms that are not explained by the demonstrable severity of disease.

Use of CarePrep to better allocate clinic resources. Where the CarePrep assessment can be obtained before the patient's appointment is scheduled, CarePrep data can be used to predict the type and length of clinic sessions that would be appropriate for the patient. The CarePrep data on the number and severity of physical symptoms will predict the complexity and time required to assess physical symptoms by the medical clinician. Likewise, the number and severity of psychological issues, life stresses, social or behavioral issues and the impairment of quality of life will predict the time that needs to be devoted to exploring these problems and determining their relevance by a clinician, psychologist, or social worker.

Initially, simply the scores for the various domains can allow a clinician or trained clerk to estimate the complexity of issues the various domains and therefore the patient's requirements for and length of clinic visits with physicians, psychologists, social workers, physician assistants, or other clinicians, depending on the skills, preferences, and cost-efficiencies for optimal use of clinic resources. To further enhance this process, modeling will be used to more accurately predict time allocation of clinic resources, providing time estimates for care directed at physical symptoms, psychological issues, and social problems. The number of active medical problems and conditions will also be used to estimate time requirements.

These estimates of required time based on the patient's bio-psychosocial domain scores will be refined using feedback from users about the actual clinic time taken for a given patient. Such empiric data will support more sophisticated modeling of required time based upon domain scores and experience relating such scores to elapsed time used in clinic. These relationships will also be adapted for specific clinicians, by individualizing the relation between domain scores and elapsed time based upon their actual practice patterns and preferences for managing problems in the different domains.

Data on the complexity of the patient's issues in various domains will also provide specific justification and documentation for coding and billing purposes of elapsed time in clinic used for assessment and treatment of problems in each of the targeted domains. Only with this justification will it be possible for clinicians to bill and get paid for the extra time devoted to the effective care of complex cases. This is a critical link in arriving at a practical management strategy for complex cases.

To this end, research is being conducted with CarePrep to determine if identifying complex patients at the outset of care and then providing adequate clinician time to assess the patient, plus psychosocial support as appropriate, will in fact lead to improved outcomes and lower costs. These data are essential to implement changes in management of complex cases. Only cost savings will drive change.

CarePrep will also be used to gather data on various outcome measures, including patient satisfaction and concerns about their health; clinician satisfaction with the job they were able to do and feedback on adequacy of time to accomplish critical tasks; patient or clinician estimates of past, ordered, or planned healthcare resource utilization, and actual measures of healthcare resource utilization. These outcome data will be analyzed in relation to elapsed clinic time to address a given bio-psychosocial domain and the complexity of scores in that domain to determine the minimum level of time justified for addressing issues of a given complexity.

These research data are important to justify extended visits for the medical clinician in caring for complex cases, but they are essential to justify psychological or social service clinic time or referrals, which are frequently not reimbursed now.

Facilitating clinician process. Several elements of the invention support efficient and effective clinician process. These elements include improved quality of patient data, presentation of patient data in a problem-oriented, clinical report format, generation of a problem-oriented clinical report that can be readily edited by the clinician, and efficient, problem-oriented access to relevant patient data. After the CarePrep patient assessment, clinicians are provided with patient data in a format that allows them to confirm the nature of the underlying problems and effectively pursue the appropriate steps in clinical management. A menu with options drawn from treatment guidelines facilitates clinician management decisions. Because of the inventive system's modular design, guidelines can be customized for clinical investigation or specialized applications. Alternatively, clinical guidelines in use at provider sites can be installed into the inventive system. Due to system capacity for collecting a comprehensive medical history, flagging and prioritizing important problems, and facilitating reporting and ordering, the clinician will have more time available to devote to patient-centered care issues.

Incorporating patient-centered care into routine practice. A computerized strategy, implemented at both the patient and clinician modules facilitates patient-centered care. This strategy includes a variety of functions, such as enhancing clinician-patient communication; educating and activating (priming) patients to provide an accurate history; clarifying and transmitting patient's health questions and illness concerns to the clinician; assessing the patient's health attitudes; and collecting comprehensive biopsychosocial data. The psychosocial screening assessment examines several domains, including physical symptoms that may represent somatization (a long-standing or recurrent pattern of high symptom reporting), life events that are perceived as stressful (e.g., relation, financial, and work-related stress) and psychologic co-morbidity (e.g., depression or anxiety states). The invention is designed to support incorporation of patient-centered care into routine practice by integrating these patient-centered elements into the overall management process and assessing the value of these interventions.

Several mechanisms serve to increase the likelihood that the clinician attends to patient-centered care issues. At exit and revisit assessments, the various aspects of patient-centered care are evaluated and related to data on clinician process. Issues relating to patient-centered care, such as psychosocial factors, health attitudes, illness concerns and questions, are presented to the clinician as provisional problems. These patient-centered aspects of care are implemented in anticipation that they are important determinants of the response to therapy and overall outcomes. In other words, when patients are empowered to take an active role in their care, outcomes will be improved and costs reduced.

Implementing a problem-oriented approach to patient assessment and information management. The inventive system uses dynamic, problem-oriented strategy as the basis for patient assessment, facilitating clinician process, and provider access to patient records. In accordance with this concept, the Joint Commission for Accreditation of Healthcare Organizations (JCAHO) requires problem lists for all patients. However, conventional methods for generating and maintaining a clinically-relevant problem list for each patient add to clinician workload. Due to marginal benefits from this increased workload, clinician compliance is poor.

The inventive system analyzes standardized patient assessment data for symptom patterns that comprise appropriate provisional problems. A provisional problem list is formulated, optionally confirmed with the patient, and then presented to the clinician. The clinician reviews the provisional problems, modifies them as appropriate, and assigns a working or final diagnosis. Upon revisits, the system provides efficient access to prior patient data and simplifies updating of problem-oriented patient information.

Positive and negative criteria for symptom patterns are used to define provisional problems. These criteria are implemented in a flexible format that allows for continual refinement as experience is gained.

However, clinicians are given control over problem designation. They can edit problem names, combine, or separate problems as the clinical picture unfolds. Identified problems are linked to management algorithms; following problem identification, diagnostic and treatment options are presented to the clinician for selection or modification. The problem management strategies can be customized for various practice settings or applications, such as incorporating management guidelines adopted at specific provider sites, conforming to the practice patterns of individual clinicians, or implementing randomization protocols for controlled clinical trials.

TABLE 4
Problem-oriented Access to Patient Information
Data regarding specific problems can be structured with the following
components, which are also useful for allowing access to information
relating to any of these elements:

| | |
|---|---|
| 1. | Problem name |
| 2. | Problem elements, such as symptoms, functional limitations, |
| | procedures, or operations that are related; or personal or family |
| | history of related conditions, |
| 3. | Problem summary |
| 4. | Patient-entered CarePrep data: |
| | Initial: defining or clarifying related symptoms and key features |
| | Update: reassessment of symptoms, interval history, change |
| | in symptom pattern, compliance with medication, lifestyle |
| | measures, etc. |
| 5. | Clinician notes or updates regarding symptoms and history: |
| | Initial assessment |
| | Update |
| 6. | Clinician-reported physical findings: |
| | Initial findings |
| | Updated findings |
| 7. | Relevant laboratory and procedure reports, pathology by date |
| 8. | Assessment: Diagnostic impressions or comments. |
| 9. | Diagnostic and treatment plans, referrals, revisits, etc. |
| | Initial plans |
| | Updated plans |
| | Management milestones |

The clinician module: the problem-oriented CarePrep record. From the clinician's standpoint, problem-oriented access to patient records is one of the most valuable elements of CarePrep. The current practice of many clinicians using EMRs is to copy and paste previous notes, thereby generating voluminous, redundant text, obviating some of the advantages that EMRs offer for increasing data accessibility. With the proliferation of unstructured provider notes, it is often difficult to find information on management of any given problem. CarePrep makes both patient-entered and clinician-entered data more accessible, allowing all information on a given problem to be readily retrieved.

Problem elements that comprise a given problem can optionally include symptoms, symptom groups, other symptom-related features, personal or family history of medical conditions, tests, procedures, treatments, allergies, preventive health issues, impaired quality of life or functional status, disability, or any other data that might relate to or constitute a health-related problem. All data elements used for gathering patient-entered data can be topic- or problem-tagged at content-authoring time.

The home Web page for a given patient's data has three major components: 1) alerts; 2) a summary of scores for symptom, psychosocial, and quality of life issues; and 3) problem-management data listing relevant, provisional, and inactive problems. Relevant problems are the ones that are judged by the clinician to be important to the patient or their health situation at the present time. Patient-entered data are initially presented to clinicians as a list of provisional problems, sorted by patient priority or potential medical importance within patient designated categories of active, controlled on medicine, and past or resolved. The name of the provisional problem is initially set by CarePrep based on author criteria. Clinicians designate which provision problems become relevant problems; clinicians can combine separate problem entries into a single problem, separate combined items, or move elements between problems; and they can edit problem names. Clinicians can also move problems into an inactive list. If the patient again reports symptoms or other issues that the clinician has moved to the inactive column, these issues will be moved back to the provisional column and flagged. New patient data entries will also be highlighted.

When the clinician clicks on a problem, the subcategories detailed in Table 4 become visible. Each heading has a separate field to display and enter data. Tabbing or clicking moves the focus between fields; and data can be entered directly in that field, without needing to open another window. Each field is a time series of prior entries; the default setting will display the prior and current entry, but the user has the option to display any number of prior entries. Defaults for the structure of these subheadings can be optionally adapted to the needs of a particular clinician or provider organization.

The problem summary is a key section to reduce redundant entries. The clinician writes the problem summary and then any subsequent clinician can update the summary. Past summaries will remain available in a time series for review.

The entire problem list, a given problem, or a problem element can be sorted or filtered by date, clinician, or type of problem. Likewise, any slice of a time series related to any aspect of a problem can be displayed, for example looking for all treatment and treatment-related side effects for a given problem, or any set of problems. For example, the clinician may wish to see all problems related to gastrointestinal conditions entered by a given clinician or by any clinician or all side effects related to medications.

Patient-entered CarePrep data populates and, for revisits, updates the patient symptom history (Table 4). Data for any given variable will be underlined as a link when past data exist; clicking on the link will reveal the past data in an optional graphical display or tabular display. The clinician can edit information gathered by the invention or add comments. Optionally, if the clinician's evaluation of the patient reveals incorrect CarePrep data, the clinician can reset the state of these variables. Analyses of problems are then reassessed, based upon the new state of the variables. Clinician editing is recorded separately, so that the author of the changes and the source of the information are recorded.

Clinician updates and physical findings are then entered. Laboratory data or reports from procedures are populated by clinician entry or by query of the provider EMR or other data repositories, when available. The clinician can enter impressions or comments and, where appropriate, enter plans or select plans from a menu of management guidelines, linked to a given problem type.

Health prevention issues can also be processed as a problem entry. Interventions relevant to the provider organization are listed as treatment options. These interventions might include vaccinations, pelvic examinations, Pap smears, or colonoscopy.

This strategy for problem-oriented data management provides quick access to information regarding any given problem. It reduces the risk of dilution of important information by unnecessary repetition (copy and pasting of prior notes). Economy of entries translates into greater accessibility of data. This problem list becomes the core of the medical record for capturing the patient-clinician interaction.

This functionality satisfies Joint Commission on the Accreditation of Healthcare Organizations (JCAHO) requirements for a maintained problem list. The relevant problems that are edited in a given clinic visit are also generated as the problems populating an encounter form and documentation for the encounter; these were the issues dealt with during the encounter.

CarePrep as interoperable core functionality for electronic health data systems. There is great need in the United States for interoperable electronic health data systems, meaning that data for a given patient can be shared among practitioners caring for the patient. The current landscape is fragmented, with multiple products in personal health records for patient use and EMRs for clinicians and provider organizations. None of these systems currently has a useful mechanism for gathering or tracking patient subjective data for the domains targeted by CarePrep. Furthermore, if one wants to know what is going on with the patient, do not ask the clinician, ask the patient, and that is what CarePrep does. Despite the promise of EMRs, as noted above, clinician EMR progress notes are generally unstructured, redundant, and difficult to quickly review for issues such as a specific problem or prior treatment. Clinicians often end up not taking the time to find and read the relevant information.

Because CarePrep can gather, display, and track patient- and clinician-entered data in a problem-oriented way and because it can be accessed by patients or clinicians from anywhere in the world with an Internet connection, it has unique functionality supporting both the longitudinal care of a patient and the collaboration of clinicians caring for the patient. The CarePrep utility can operate as a standalone system, allowing various clinicians, such as psychologists and physical therapists, who generally cannot afford an EMR to contribute to the patient's record. CarePrep can also operate alongside EMRs, as a window for displaying and updating patient- and clinician-entered data. A CarePrep report, or any set of CarePrep data, can be uploaded into an EMR or data repository using standard protocols for communication.

CarePrep will serve as the core of a streamlined, interoperable data entry, storage and communication tool for clinicians caring for a patient. Access to the data will be controlled by the patient. The optimal embodiment for security is to require clinicians to separately register to use CarePrep; their license and other data will be authenticated. Secure passwords, periodically updated and controlled access by VPN (virtual private network), known IP address, or IP address simulation will be required.

Through the CarePrep patient module, users can review lists of authenticated clinicians on the system, organized by region or provider organization, as appropriate, and offer or withdraw permission for access. Patients can also audit who has accessed their information. Patient will also be asked to use secure passwords and IP access control, as noted above.

The clinician module will also have the optional capability to import data from provider organization EMRs or other data repositories, such as laboratory result databases, relating to tests, procedures, medication lists, or other topics that can be displayed for clinicians using a consistent GUI in dedicated windows or problem-tagged so that these elements can appear in association with any given problem. These data access routines use standard communication protocols and data tags, or specific references to data types or tags unique to a given data repository.

Clinical applications of process and outcome measures. Integrated measures of clinician process and patient outcomes from real practice settings, as captured by the invention, provide powerful measures of the human, social, and financial impacts of medical care and treatment interventions. The invention provides practical tools to collect consistent, reliable data on patient assessment, patient outcomes, and clinician process. Using these integrated data, the invention supports rigorous clinical investigation of specific treatments. The system also provides a practical means to test, implement and monitor disease management strategies in real practice settings. Lastly, the generation of linked process and outcome measures provides a unique mechanism for integrated quality assessment and improved management of common disorders in outpatient settings.

Efficient patient management requires adapting management strategies to the attributes of individual patients. Appropriate diagnostic and treatment interventions differ drastically in population subgroups, such as the elderly, children, or women of childbearing age. To this end, the invention accommodates real-time adaptation of communication strategies, question sets, and management algorithms for patient characteristics, including age, gender, socioeconomic and educational background and medical history. Since the occurrence of many diseases varies with patient characteristics, particularly age and gender, individualized management strategies will be more cost-effective than broad-spectrum approaches for all patients.

Database/Server. Both the patient and clinician modules are linked to a database which captures raw patient data (initial clinical assessment, quality of life and response to therapy), provisional problems, patient verification of the identified patterns, clinician process (observations, impressions and treatment), clinical impressions and diagnoses, and long-term follow-up. Using standard communication protocols, the invention can query other electronic medical records systems to obtain other patient data, per patient costs and utilization of health care resources, laboratory data, consultations, surgeries, and pathology. Utilities will be provided to monitor data integrity, prevent duplicate records and safeguard data security and patient confidentiality.

Modular System Design. The inventive system uses a modular design to support efficient development, refinement, and expansion of the assessment process and clinical strategies for health care management. Modules are used for clinical content and logic, facilitating facilitating development, refinement, and flexible use to adapt the interview to specific purposes. This modular design supports expansion of the system to achieve utility in a wide range of clinical, research, and administrative/quality improvement applications, thereby enhancing the utility and value to clinicians, patients, provider organizations, and investigators. With this modular design, physician-editors can create and refine the questions, other displays, and the clinical strategy without reprogramming the system code itself. The modular design allows the accumulated knowledge in the database to be translated into continuous refinement of these algorithms.

The system and strategy will be adapted for a wide range of computer platforms, networks, and Internet applications. The modular design supports applications for the full range of provider organizations as well as individual patients seeking to better understand their symptoms or guidance regarding health care options.

A consensus resource for patient care, research, and quality assurance (QA). The inventive system will serve as a consensus resource for the goals of advancing patient care, research, and QA. CarePrep is being made available to professional organizations and investigators in targeted fields in sequence to advance these goals. These activities are optionally conducted by a nonprofit organization dedicated to advancing research and quality improvement in healthcare; this is the best way to build the credibility, transparency, and consensus required to achieve widespread use of CarePrep to advance these goals. Further participation in this nonprofit activity is being sought from other relevant stakeholders interested in research, patient care, QA, training, or optimizing cost-effectiveness of care, such as payers, insurers, patient organizations and advocacy groups.

Benchmarking and quality improvement of clinical performance. Conscientious clinicians want to know how they compare against other clinicians for treating various disorders. Benchmarking would be a useful resource to evaluate the success of individual clinicians, especially for complementary or holistic practitioners. With CarePrep developed as a consensus resource, it can be further used as a benchmarking and quality improvement tool for professional organizations, investigators, and practitioners. The ability to monitor patient outcomes over time creates a resource for comparing or benchmarking the effectiveness of various treatment strategies in practice settings. This benchmarking capability will be statistically adjusted for case complexity, which will influence treatment responsiveness. Furthermore, this benchmarking capability can highlight the effectiveness of different treatment strategies or different practitioners. Professional organizations and practitioners can use these data to target quality improvement programs to practices that are underperforming. Benchmarking data would be completely confidential to the individual clinician; fully de-identified, pooled data would be available by region or field for comparison. At the discretion of the clinician, benchmarking outcome data can be made public to allow patients and payers to evaluate the comparative effectiveness of different clinicians and treatment approaches. This benchmarking capability will be sequentially developed for different disciplines when the testing of validity and reliability of assessment content and logic has been completed.

Applications to clinician or student training. The inventive system will be useful for training or re-training medical students and other clinicians in the art and practice of clinical evaluation. The patient undergoes a clinical evaluation by the trainee either before or after also doing a CarePrep assessment. One or more of the following sequences will be used: the trainee reviews the CarePrep assessment before or during their clinical assessment of the patient, or the trainee completes their assessment then reviews the CarePrep data in relation to his or her assessment and in relation to further discussions with the patient or with instructors to resolve conflicts and clarify issues. Different modules of content can optionally be used at different stages of training to expose trainees to desired part of a comprehensive bio-psychosocial assessment.

### DETAILED DESCRIPTION OF THE INVENTION

### The Structure and Function of Basic System Components

FIG. 1 depicts the salient components of the present invention as it resides in the medical clinic environment. The system employs one or more client-server computers, with all workstations accessing system programs and providing select services via the Internet or a local area network. The patient carrel 10 is equipped with any computing device capable of connecting to the Internet or a local area network. These workstations communicate over the local network or Internet with the central support server/database 30 to provide the requisite functionality to patients and clinicians, as will be discussed in more detail below.

In addition to the patient carrel 10, the admitting clerk is equipped with a workstation 5 for entry of select, patient-specific information that serves to create a patient record for this clinic visit and generate data entries or updates for the server/database 30. For example, the admitting clerk collects or confirms simple biographical information (e.g., address and phone number).

Continuing with FIG. 1, optionally a nurse utilizes workstation 20 for entry of vital signs (temperature, blood pressure, pulse, and weight), that are generally taken during each clinic visit. These data are added to current visit data entries and stored in the database. Using prompting screens, a nurse or clerk can also collect the patient's chief complaint (why the patient has come to clinic) and determine whether any emergent situations exist. Provisions are also made for direct entry of data regarding presenting complaints and potentially emergent problems.

Finally, the clinician workstation 40, typically placed in the examining room, operates to provide the clinician with CarePrep problem-oriented patient evaluation and optionally with prior data, if available, and management guidelines. Physician workstations communicate with the CarePrep server/database 30. In addition the CarePrep clinic system can utilize the communication server, 15, to interconnect with the provider's central electronic medical record system to upload clinical reports or obtaining patient data; one or more servers can fulfill the functions noted for items 15 and 30 (FIG. 1). In addition, the CarePrep system can connect with third party systems, such as insurance companies via network, Internet, or modem applications. In the usual application, CarePrep servers would be accessible to patients and physicians from their homes or other sites.

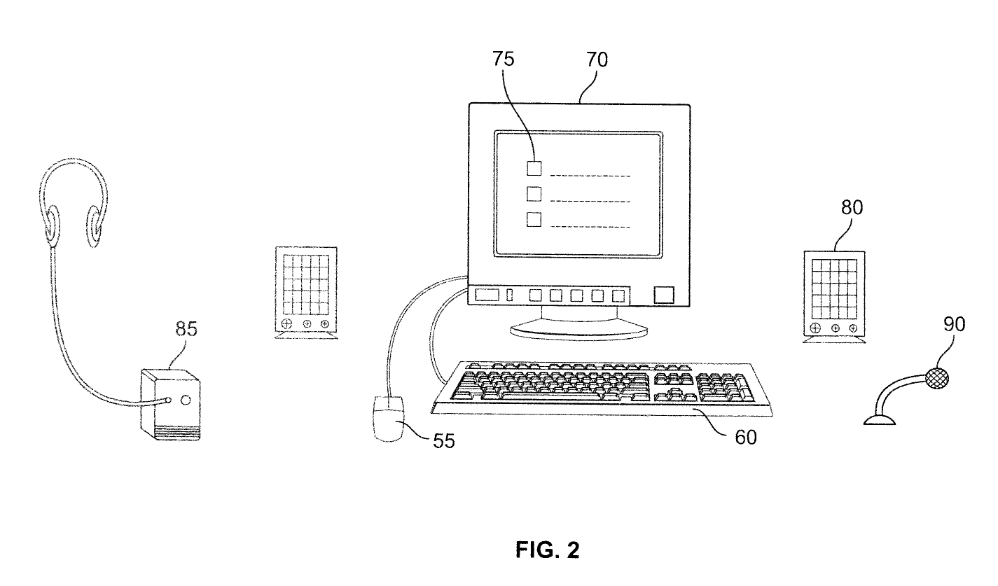

In the exemplary mode, patients use from their own computers at home or at a patient carrel 10 in clinic (FIG. 1) to directly input their health data. This in clinic patient carrel can be configured as depicted in FIG. 2, comprising a display terminal 70 for presenting questions and other information and a touch-sensitive screen, which has icons 75 and text to guide the patient through the assessment module. In addition, the system has the capacity to record patient comments via microphone 90, and an option for speakers 80 or a headset and volume control 85, to allow the patient to listen to voice synthesized or previously recorded questions and text. Further optional input means include mouse 55 and keyboard 60.

### The Flow of Information for Patient Assessment and Physician Process

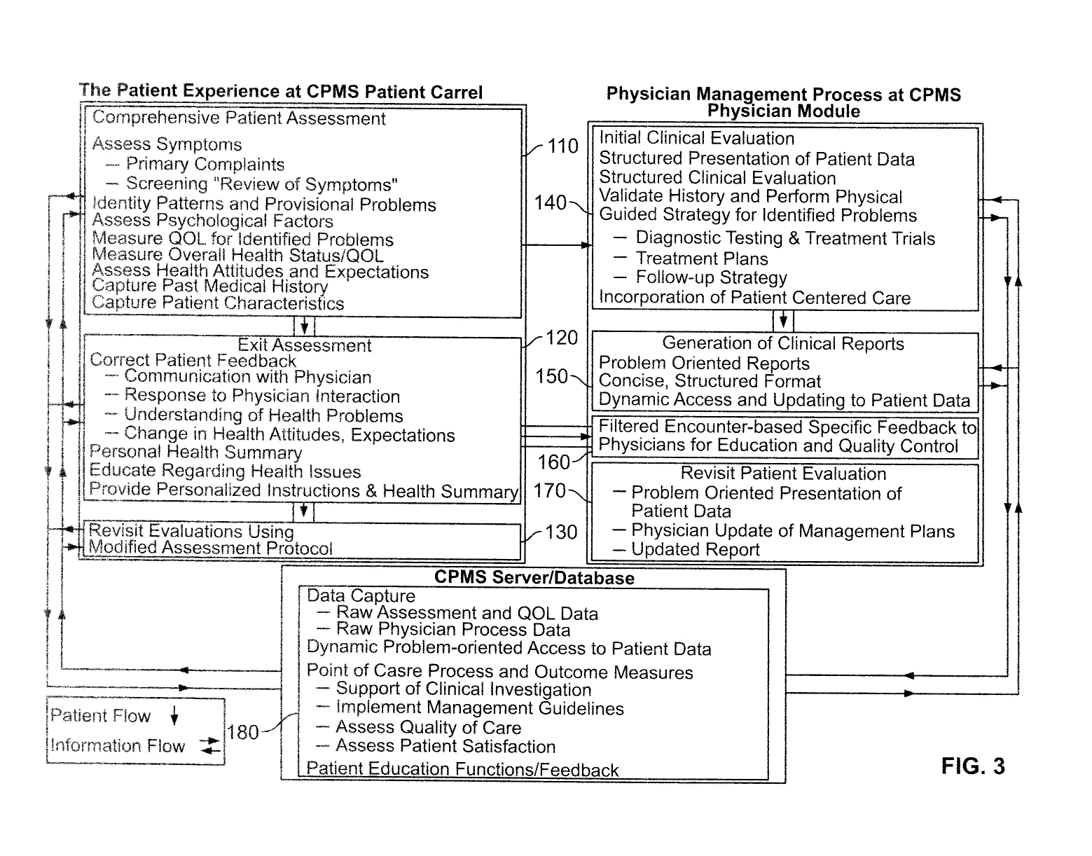

The patient experience and information flow through the system is depicted in FIG. 3. Patient sessions at the patient carrel are illustrated on the left side: the initial CarePrep assessment before seeing the clinician, 100; an CarePrep exit or follow-up session after the clinician evaluation, 110; and a CarePrep revisit evaluation, 120. The issues addressed during the initial and exit sessions are highlighted in FIG. 3 (100 and 120, respectively). Upon returning to the clinic, the patient undergoes a revisit evaluation at the patient carrel, followed by a clinician visit and an optional exit session. The protocols for these revisit sessions will be modified from those outlined for the initial and exit sessions, as described subsequently. For each of these sessions, bi-directional information exchange occurs with the CarePrep server/database, 180. The system queries patient information necessary for conducting the session and patient data, problem summaries, and concatenated reports are sent to the server, 180.

Activities and information flow at the clinician module are illustrated on the right in FIG. 3. At the outset of the initial patient evaluation, patient data summarized from the patient CarePrep session are presented to the clinician, as described above. The clinician module guides the clinician through consideration and editing of the patient data, 140, thereby validating these data. The clinician can also input other assessment data (e.g., other problems or physical findings), select management options, and select patient education materials. The final report is completed, 150, based upon these data generated from the patient CarePrep session, as edited by the clinician. Depending upon system setup in the provider environment, the clinician will receive filtered feedback from the patient exit session, 160, regarding the patient's understanding of what was communicated and their response to the process. For the revisit session, 170, the clinician will be presented a problem-oriented summary of the initial problems and interim status collected by the invention. The server/database, 180, supports both the patient evaluation and clinician session and captures data from these sessions.

### System Use in Practice Settings

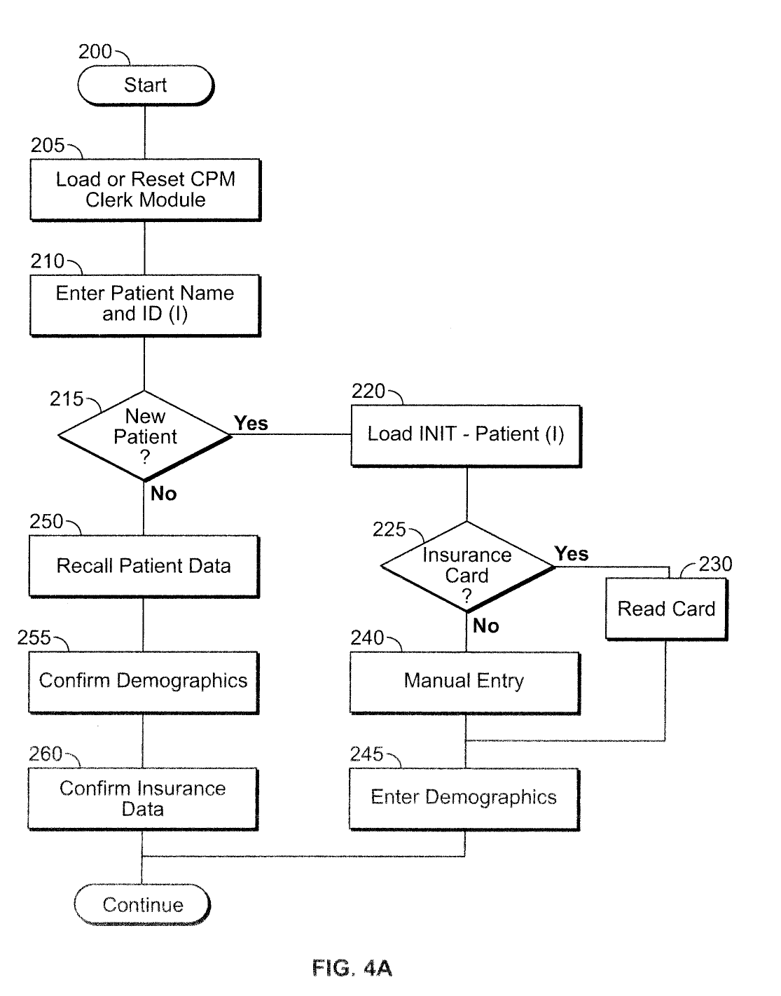

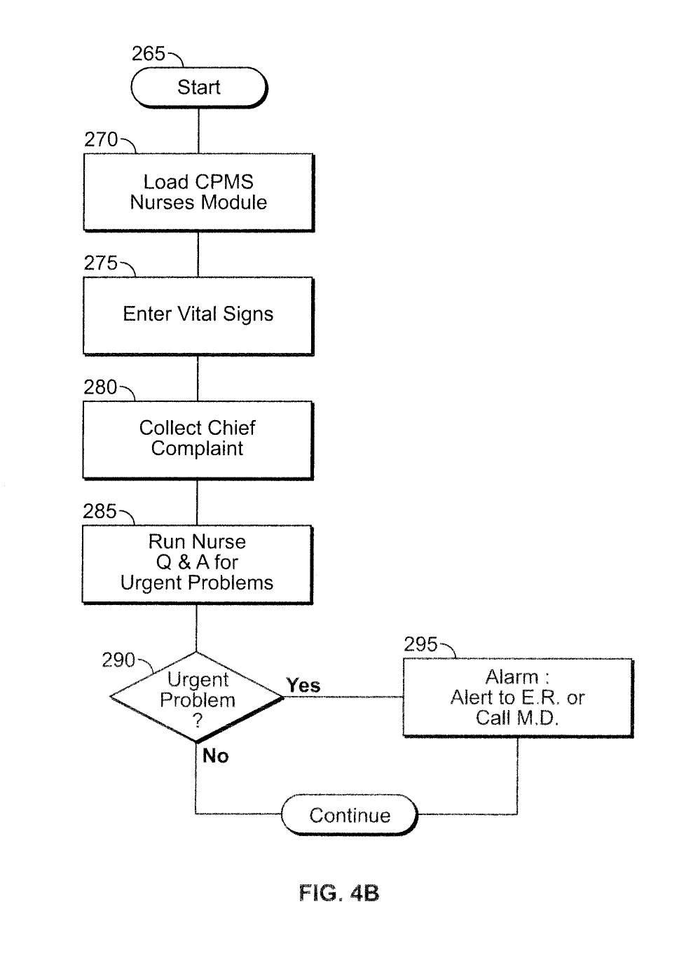

Patient sign-in and nurse assessment. Turning to FIG. 4A, system operation is optionally initiated when the patient signs in or sets up an appointment with the clerk. The clerk accesses the CarePrep system, 200, and creates a new patient in the system, 205. The clerk enters the patient's name and identification, 210, and the system queries the server/database to determine if prior records for this patient exist, 215. If yes, logic branches to block 220 and the system presents screens for input of patient information by the clerk, 220. At test 225, the system determines if the patient has a pre-programmed insurance card (e.g., Smartcard) or other accessible data for downloading of information into the CarePrep file. If yes, logic branches to block 230 and these data are extracted and placed in the patient record. If no, the clerk manually inputs data, block 240. Basic biographical and demographic data are then entered by the clerk, 245. If at test 215 the patient is found to be revisiting the clinic, logic branches to block 250; prior patient data is read into memory and displayed on the clerks screen for confirmation of demographics, 255, and insurance data, 260.

Initial assessment. For home use, the clerk can personally communicate the user ID and password to the patient or can request the system to send an email with the sign-on information. In instances where CarePrep is used in clinic settings, the patient would then optionally be escorted to the nurses or clinic coordinator workstation where the system is started or reset for the new patient, 265, the nurse/coordinator module is accessed, the patient's record accessed, 270, and vital signs are entered, 275. The nurse then optionally enters the chief complaint (the reason or reasons why the patient has come to clinic), 280, and optionally responds to the questions and answers, 285, regarding whether this is an urgent situation. These questions probe for problems such as a new onset chest or abdominal pain, bleeding or shortness of breath that might reflect serious heart, lung or gastrointestinal disease. If the answers indicate a situation that warrants immediate attention by a clinician, yes at test 290, the patient is escorted to the emergency or urgent care facility or the case immediately reviewed with a clinician. An option is also available for this initial input of information (steps 200 to 290) to be conducted at the patient carrel by a single clinic worker. Alternatively, the system has an option for the patient to initiate the session from home or other sites without outside guidance.

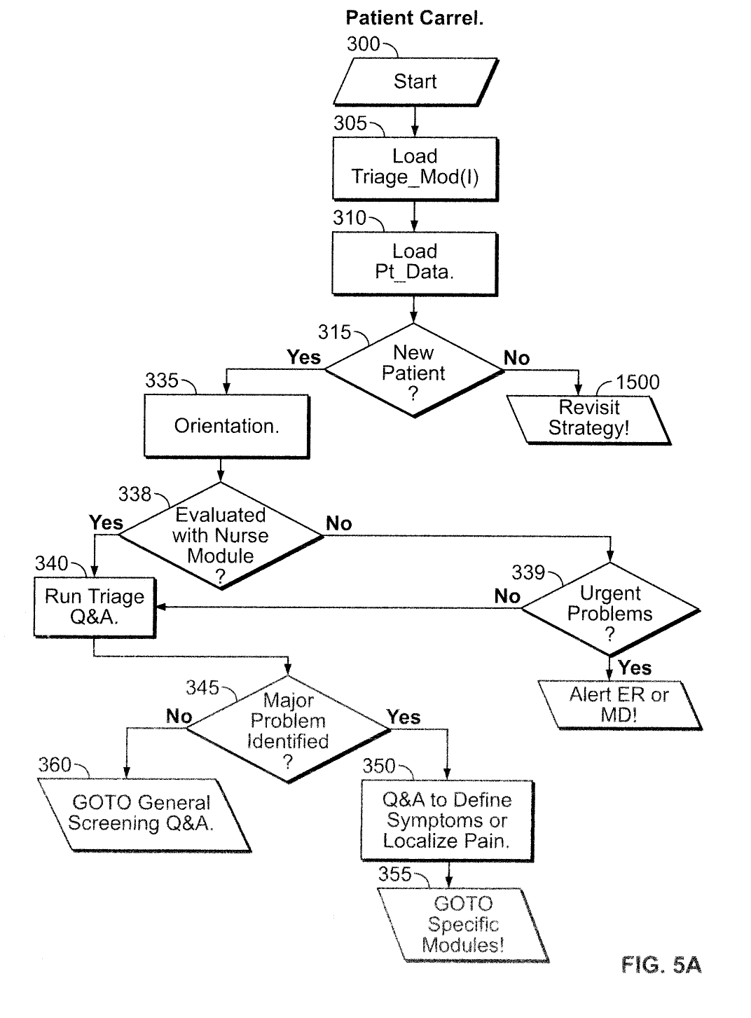

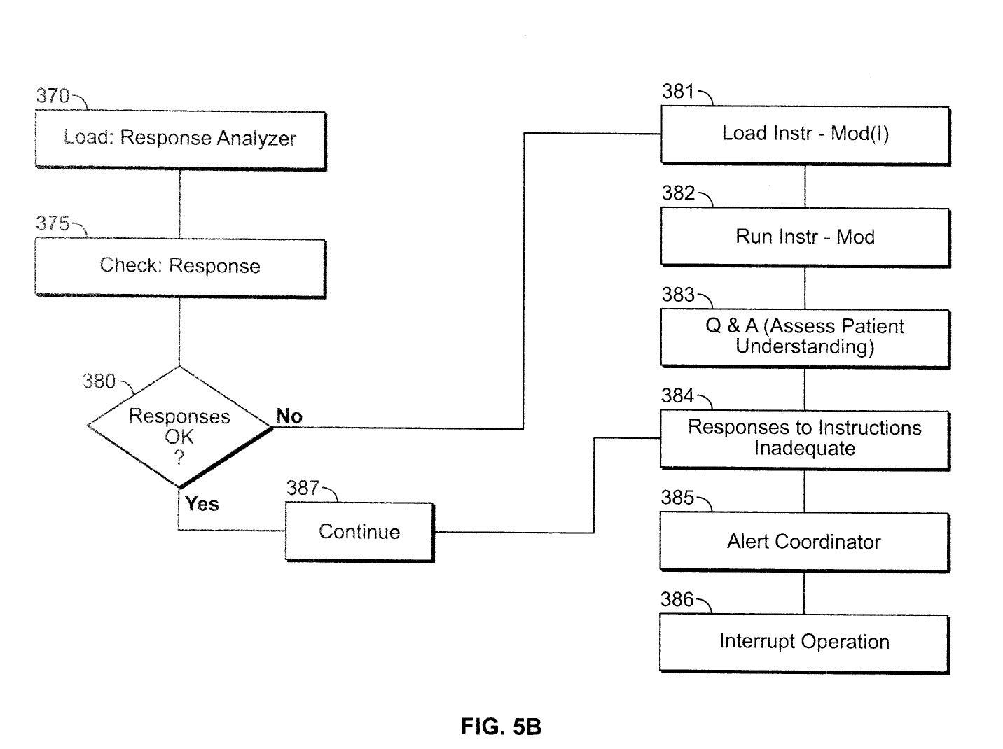

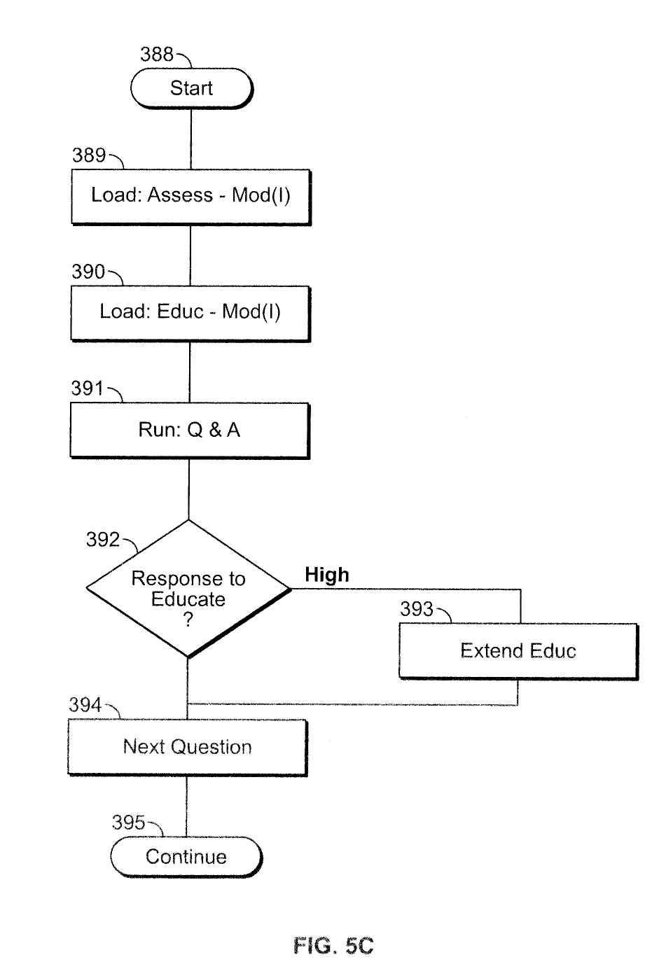

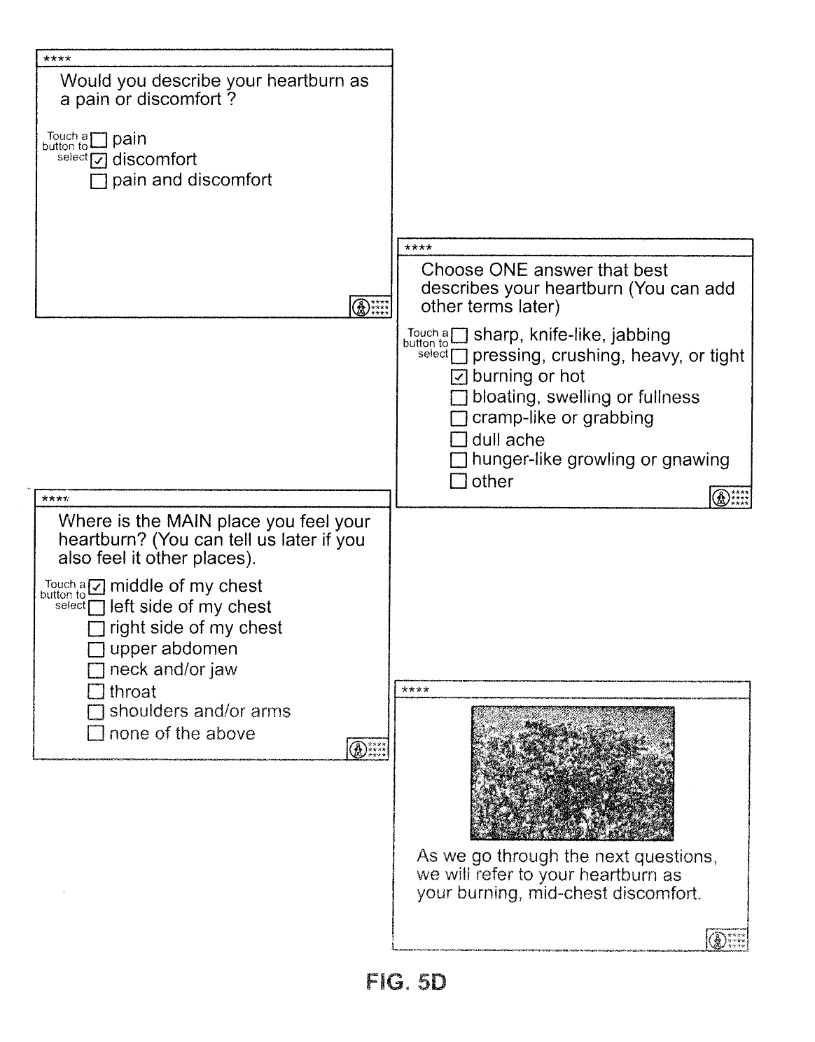

In the exemplary mode in clinic, patients will be escorted to the patient carrel to begin testing (FIG. 5A). Logic conceptually begins at block 300 with starting and loading of the CarePrep triage module, 305. Following system access, the initial data collected from the admitting clerk and nurse are loaded into active memory, block 310. Logic continues to determine whether the patient is new to the system, test 315. If the patient is new to the system, a multimedia tutorial in CarePrep system use and the evaluation process is presented, 335. This education package will be adapted to the patient's characteristics, such educational background.

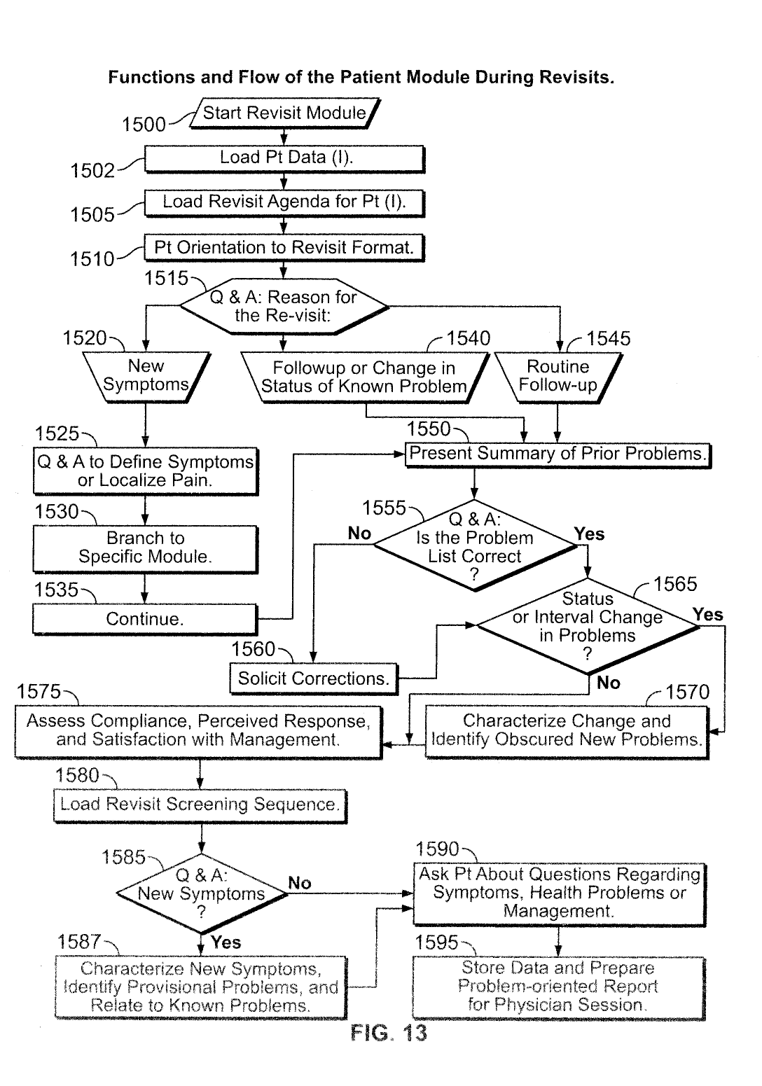

If at test 315 the patient is known to the system, the existing file on the patient is recalled for a revisit protocol, block 1500 (FIG. 13).

If the system is operating without a nurse (No at test 338), the next sequence determines if the patient requires immediate medical attention and then obtains the primary purpose of the patient's visit. These questions, block 339, are adapted from the nurse module, (FIG. 4B, blocks 275-285). If concerning symptoms are found in this mode, an alarm is activated to call clinic staff and the evaluation is terminated.

The next order of business is a sequence of triage questions, block 340. This initial triage obtains structured data regarding the principal reasons that bring the patient to clinic, thereby informing the system where to being asking more specific questions. In the triage screen 340, patients are asked whether they are presenting with pain, discomfort, or other symptoms (e.g., dizziness, coughing, bowel problems, or ankle swelling). Patients are optionally questioned about other health care issues they want the clinician to review. If a major problem is identified at block 345, more detailed questions are presented to further define the symptoms or localize the pain, 350. These triage data allow appropriate branching to specific modules to characterize these problems of central importance to the patient, 355, before returning to complete screening questions. If the patient is presenting for routine follow-up or does not have new symptoms, then screening questions are asked, 360, as illustrated subsequently.

Assuring accuracy in patient assessment. Three approaches optionally are used to increase and monitor the accuracy of patient answers:
1. Question screens can be set so that at least one answer is required. When the patient attempts to advance to the next screen, a message box appears instructing them to make a choice if the patient has neglected to provide at least one answer.
2. On most question screens, a final response is included that is exclusive of the other answers (e.g., none of above). If the patient checks the final response plus any of the mutually exclusive responses, then a message to correct the answers is generated as the patient pushes the screen advance button. If the patient does not correct the answer, then the process is interrupted and clinic staff are alerted to attend to the problem.
3. Finally, a system response analyzer (block 370, FIG. 5B) and operates in the background to track inconsistent responses. The response analyzer detects responses that reflect either a failure in understanding and appropriately responding to questions, or a patient uninterested in participating in the process. The response analyzer checks the patient's responses after each question set, block 375. If the responses are acceptable, block 380, the system continues at block 387. If responses indicate a problem exists, an instructional sequence is loaded at blocks 381-382 and runs to inform the patient of the nature of the problem and proper system use. At block 383, questions are asked to determine if the patient understands the problem and the instructions. If the response is acceptable, the process is continues at block 386. If not, clinic staff is alerted and the program is interrupted, blocks 385-386. Since the accuracy of patient responses is critical, patient understanding is tested early in the assessment process by embedding several questions with potentially inconsistent responses. Conflicting responses are monitored by the response analyzer as described above.

This process also reveals system problems due to inadequate instruction or confusing displays or questions, which will be continually revised by either CarePrep consultants or trained clinic personnel. These mechanisms provide a means to rapidly identify patients whom are having trouble with system operation, understanding questions, or maintaining interest in continuing the assessment.

In addition, at selected point in the assessment process, such as the beginning of a new question block, the system loads an education module relevant to the upcoming topic (FIG. 5C, block 388). This education module helps the patient understanding the terms and issues they need to be informed about to accurately answer questions. Continuing with FIG. 5C, the system presents the specially crafted question and answer sequence to the patient, block 391. In accordance with system instructions for that module and option settings, periodic educational clips can be provided, and the patient is requested to assess how helpful these clips are in increasing their understanding and enjoyment of the process. Questions will also determine patient understanding of the material that is presented. At test 392 these responses to the educational elements are evaluated. If the response is positive, the system branches to block 393 and the patient is given the option for extending the educational module. In either event, the question and answer sequence continues to completion, block 395, when the patient has covered the material.

A new paradigm for informed consent. An example of numerous potential applications of this modular system in a clinic setting is provided. In the exemplary mode, an interactive module that includes educational sequences and evaluation questions will be developed for collecting informed consent of patients. Applications include informed consent for routine procedures or surgery as well as for clinical investigation to meet Institutional Review Board requirements for human subjects. To improve patient comprehension, this module incorporates video clips and audio and visual aids so that appropriate information is conveyed to the patient regarding the intervention they will receive. Because the information presented can be catered to patient characteristics, appeals to a variety of learning styles with its multimedia format, and can be reviewed or repeated at the patient's pace, this sequence provides an effective means for education on informed consent issues. Evaluation questions and internal system checks (described above) assess the patient's level of understanding of the material presented. When this sequence is completed, the patient's consent can be given online or a printed form can be generated for the patient to sign. For clinical studies and trials, this method of gaining informed consent is particularly valuable due to its capacity to transmit general information on the risks and benefits of study participation, as well as to avoid contamination by catering specific information to control and intervention groups. Standardized presentation and evaluation of informed consent issues can reduce legal costs and risks. The CarePrep computerized informed consent module also yields substantial cost-savings because of reduced need for staff to conduct informed consent activities.

Variable text functions. Variable text functions provide patient-specific descriptions for each symptom (e.g., “your pressing, mid-chest discomfort” or “your burning upper abdominal pain that comes on an empty stomach”). These individualized descriptions are used to introduce screens, questions, or responses, so that the patient is clear regarding the question being asked and the symptom that is referred to. This serves to ensure simplicity, clarity, and efficacy of patient-system interactions. Screens depicting this strategy are presented in FIG. 5D.

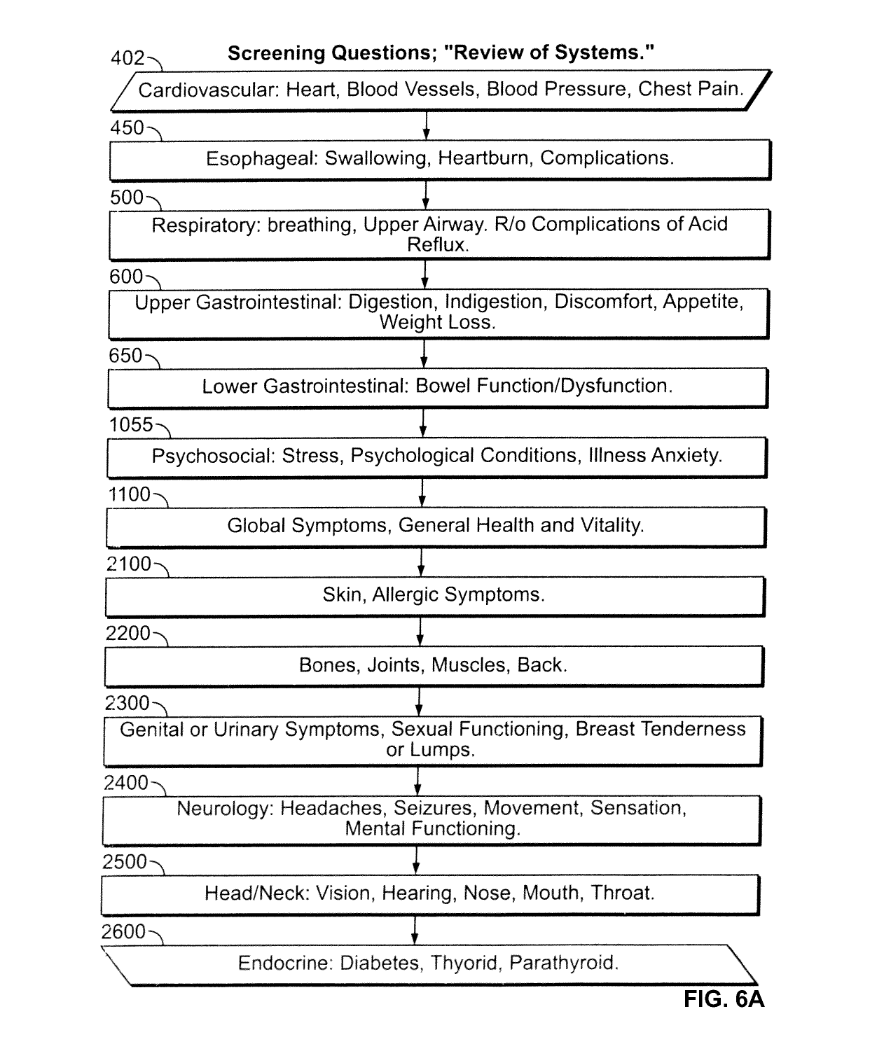

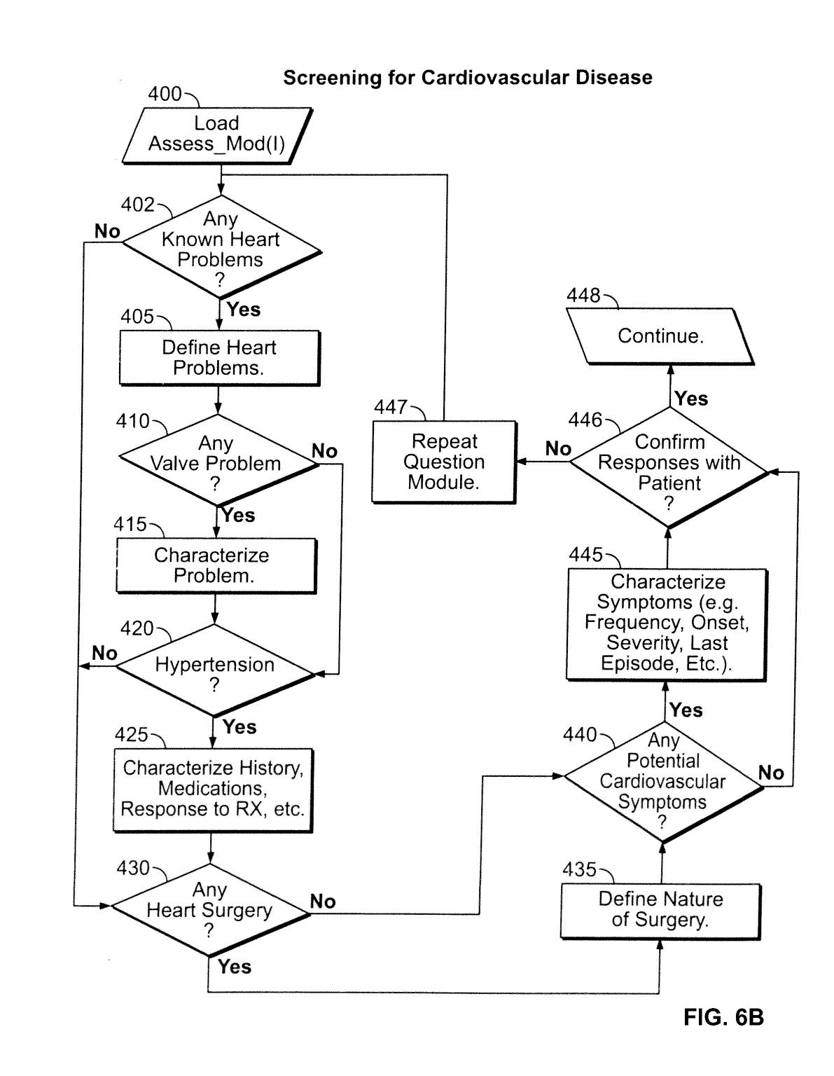

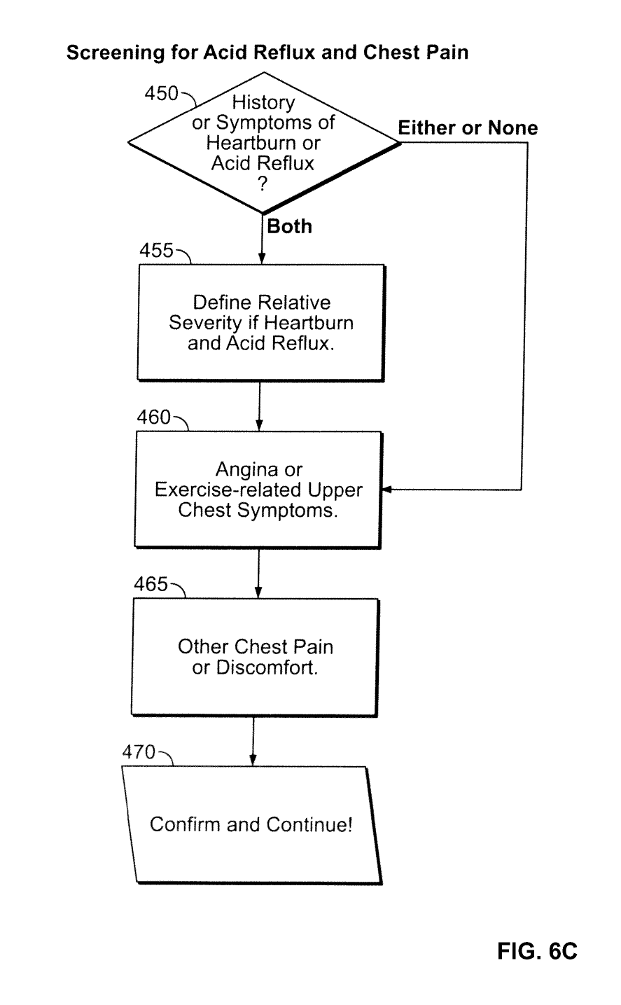

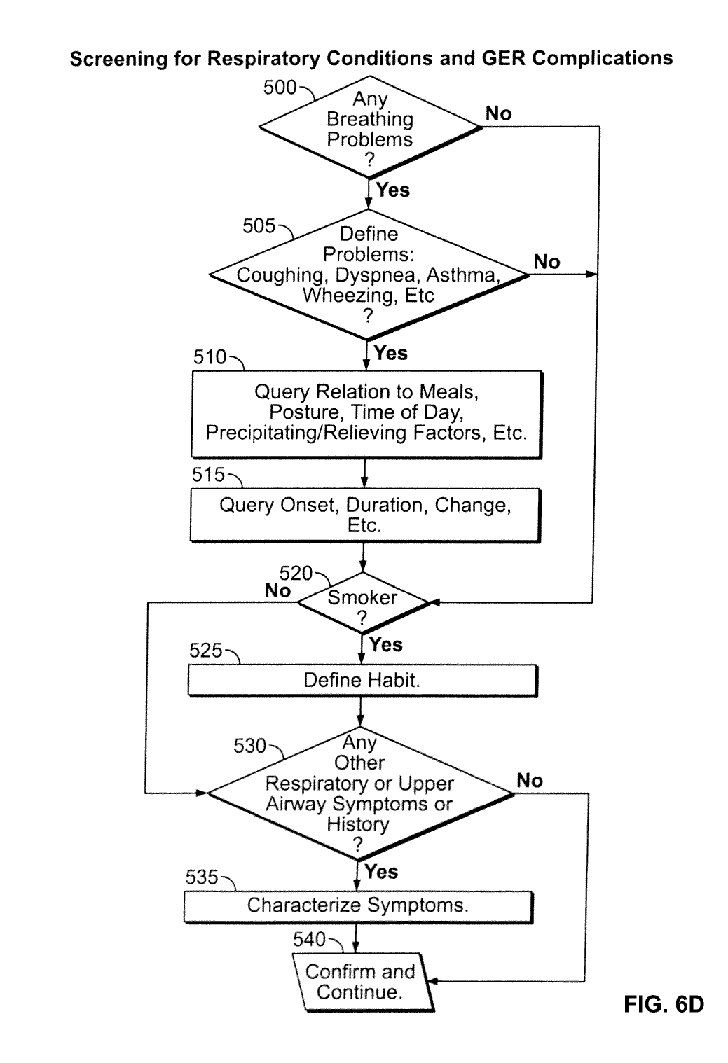

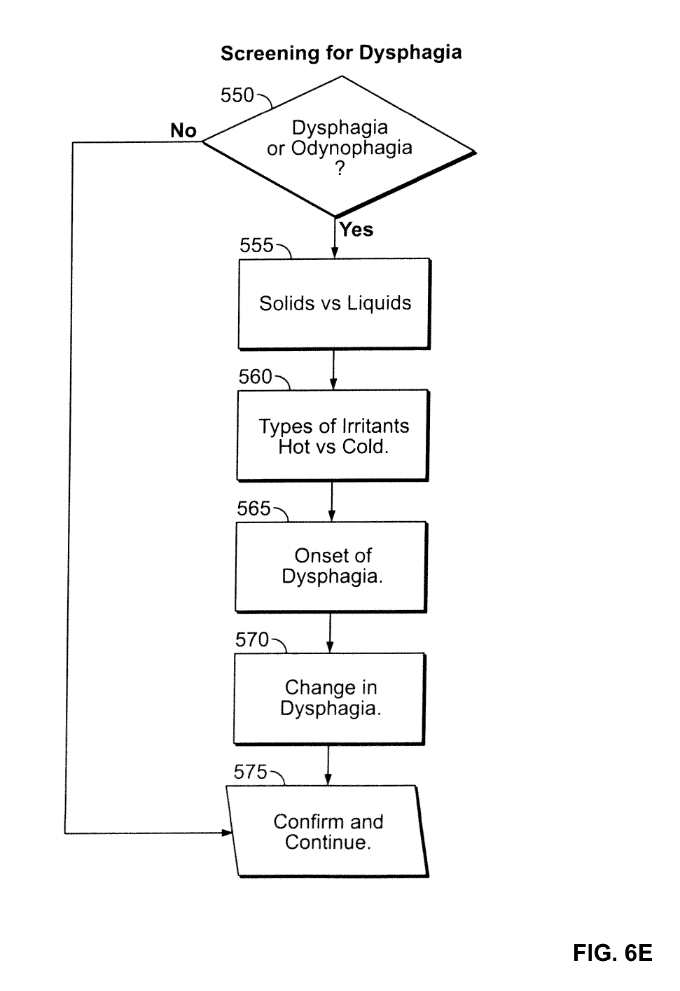

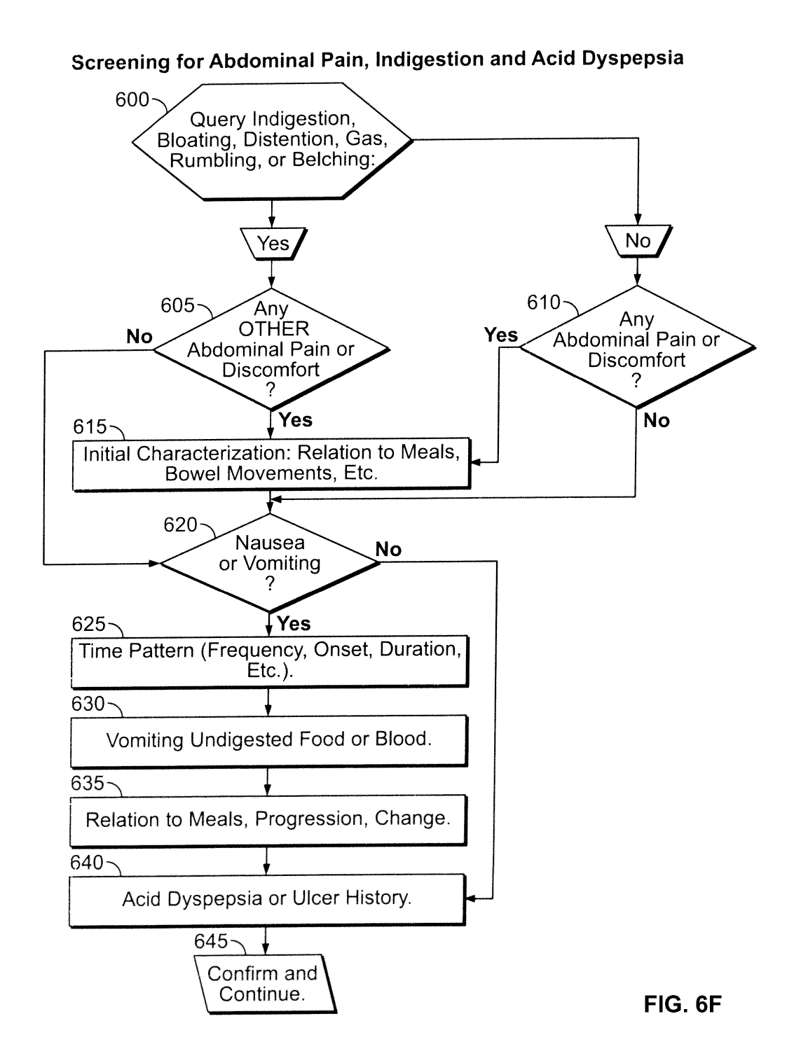

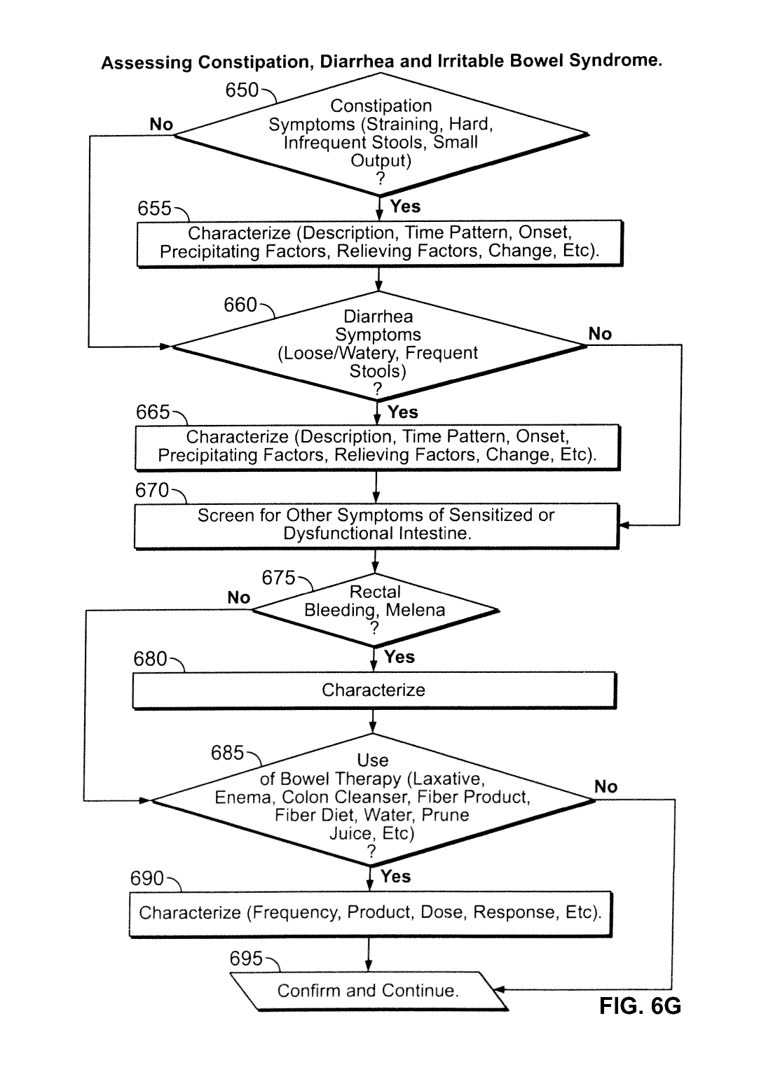

Overall assessment strategy. The next sequences involve implementation of a thorough clinical evaluation to pursue symptoms elicited in the triage module and to probe for all symptoms of potential relevance. Screening questions are first asked for the entire review of systems (symptoms) (FIG. 6A). During this survey, questions are asked to sort our current or active symptoms, from those that are past and resolved or effectively treated. These high level screening questions are asked about groups of related symptoms; more detailed questions drill down on specific symptoms. Questions are also asked about the priority of a given symptom or group of symptom, defining priority as the important for discussing the issue with the physician. This priority rating can then be used to focus subsequent questions on the patient's high priority issues.

Strategies are implemented to minimize patient confusion that might arise when patients are asked in detail about one symptom before they are clear how it relates to their other symptoms. To minimize this problem, initial screening questions are designed to establish a road map for potentially related or overlapping symptoms. In addition, the screening sequence is designed to identify probable symptom complexes.

More detailed questions are asked about potentially critical symptoms and symptoms that are high priority to the patient. For effective diagnosis, it is not sufficient to know whether the patient has a chest discomfort or an abdominal pain. Enough information must be collected to determine the possible nature of the pain: for example, a chest pain with exertion and an abdominal pain that is relieved with bowel movements. With these pieces of the puzzle, the variable text functions of the invention allow reference to the specific symptoms that have been elicited thereby allowing specific questions that can clarify the relation between symptoms. This strategy is particularly important when patients have multiple complaints, which is the rule rather than the exception.

Two general points on the questioning strategy warrant emphasis:
1. Branching is utilized so that detailed characterization is only pursued if screening questions are positive.
2. At the conclusion of a sequence of questions, patients are optionally presented with a grammatical, narrative summary of positive and negative symptoms for them to confirm or reject, block 446 (FIG. 6B). If rejected, block 447, the patient returns the screens where responses need to be changed. After the patient accepts the summary, they continue onto the next question set, block 448. This sequence is repeated for every block of questions and will be denoted in subsequent figures by the phrase “confirm and continue.” The information collected during the more detailed characterization of symptoms is also confirmed in a similar manner.

The strategy for questioning attempts to minimize patient frustration and confusion. Detailed questions are only asked about high priority symptoms, unless the symptoms may be a critical medical importance, such as chest pain. At the outset of detailed questioning, patients are given a chance to indicate whether a problem is of a minor nature and given the option to skip detailed questions. However, all symptoms are reported to the clinician, grouped by priority either patient judgment or system criteria (see below).

Screening strategy for heart, lung, and gastrointestinal problems. To implement the logic described in the above section, the first round of screening questions is designed to identify important cardiac, respiratory, and gastrointestinal symptoms at the outset of the assessment. These three modules are also called up for symptoms that appear cardiac, pulmonary and gastrointestinal in nature, since each of these systems must be evaluated for problems in any one of them. Assessing chest and abdominal symptoms poses a common and often challenging task for clinicians, since symptoms in these regions are often nonspecific, multiple, and overlapping. Psychosocial assessment screening is also included because of its general importance. The other modules that are not illustrated follow a similar strategy to clarify symptom presentation.

At block 400 (FIG. 6B), the assessment module is loaded for the review of systems and characterization of common disorders and configured for the patient based on the initial information collected and data available from previous visits. The first screening questions address a history or symptoms suggesting heart, valve, or rhythm problems (FIG. 6B, blocks 402 through 440). Continuing with FIG. 6C, a history and symptoms of heartburn or acid regurgitation are sought. The patient is then asked about angina or exercise related symptoms and any other chest complaints, blocks 460 and 465. Variable text functions are optionally used to remind patients of their prior answers, so as to avoid confusion.

Screening questions for respiratory conditions are then presented (FIG. 6D), asking about coughing, choking, shortness of breath (dyspnea), and asthma, blocks 500 and 505. Positive responses are pursued, characterizing key diagnostic clues, such as the relation to meals, posture, and time of day, block 510. Onset, duration, and change in pattern are then sought, as appropriate, block 515. Other respiratory and upper airway symptoms (e.g., sneezing, coryza, sore throat, and hoarseness) are also sought and characterized in blocks 530 and 535. If a patient has multiple respiratory complaints they are asked if these symptoms are separate or related. If a patient reports that different symptoms (e.g., cough and shortness of breath) follow the same pattern, then only one set of characterization questions is presented.

In FIG. 6E, the process continues to address pain or difficulty with swallowing, block 550. If positive, symptoms are characterized, focusing on key features that are clinically valuable for distinguishing symptom groups. For example, difficulty swallowing with solids (block 555) that is of recent onset (block 565) or progressive in nature (block 570) raises concern about a constricting lesion in the esophagus. This would be flagged for the clinician in the CarePrep patient assessment report. On the other hand, if the problem is characterized by difficulty with both liquids and solids that is intermittent and not progressive, this is typical of esophageal spasm and would be reported as such. Subtle clues such as discomfort upon swallowing with cold, hot, or irritating liquids (e.g. citric juices) can be very helpful, suggesting an irritable, rather than an obstructed esophagus (block 560). The invention implements Boolean logic to capture and recognize these clues to identify important symptom complexes.

The next set of questions pursues common upper gastrointestinal symptoms and abdominal pain or discomfort in relation to defined syndromes (FIG. 6F). In block 600, the patient is first asked about indigestion (belching, upper bloating or fullness) during or after meals, gas, distention, and rumbling. If these symptoms are present, the patient is asked whether they have any other abdominal pain or discomfort, block 605. This simple step is essential because clinicians often ask about discomfort without clarifying relation to these other common symptoms—despite the diagnostic value of this information. If the patient denies indigestion symptoms (block 600), they are asked whether they have any abdominal pain or discomfort, block 610. If present, additional screening questions about abdominal discomfort are posed: whether these symptoms occur during or after meals, in relation bowel movements, or are relieved with food, antacids, or other agents is also sought (block 615). A narrative summary of these symptoms is presented to the patient for confirmation, and the section is repeated if necessary. For positive symptoms such as bloating, distention, or gas, sufficient details are asked to characterize clinical significance. The patient is then asked about nausea and vomiting, and symptoms are appropriately characterized (block 620 to 635). At block 640, more detailed questions are asked about history of peptic ulcer or use of NSAIDs (non-steroidal anti-inflammatory drugs that cause gastrointestinal complications).

The last set of screening questions in this group is for bowel symptoms, FIG. 6G. Screening questions for constipation, block 650, and diarrhea, block 660, are presented. Because common medical terms are commonly misused or misunderstood by the public, CarePrep asks about specific features comprising a condition in simple terms, rather than using loaded medical jargon. Thus, the specific features that define constipation (hard stools, straining, or stools judged to be too infrequent by the patient) are assessed. However, additional measures of bowel problems are also queried, including stool frequency and consistency. Questions and criteria for identifying provisional problems accommodate the vagaries of these problems; for example, frequent passage of small amounts of hard stool is constipation, not diarrhea; and a single movement per day that is foul or loose may reflect an important “diarrheal” condition such as malabsorption. If screening symptoms for bowel problems are identified, then detailed characterization is sought (blocks 655 and 665). Screening for symptoms that may reflect a dysfunction, disease, or sensitized bowel are also sought, including incomplete evacuation, urgency, or bleeding (blocks 670 and 675). Use and benefit from various bowel therapies are also sought (blocks 685) and characterized (blocks 690); use of these agents may reflect specific bowel problems, preoccupation with bowel function, or abuse of agents that can cause long term morbidity (e.g., senna or cascara). Finally, the patient is presented with confirmation screens that permit repeat of indicated question sets (block 695).

Additional screening questions are summarized for several other areas in FIG. 6A (blocks 2100 to 2600), although these are not illustrated or described in detail. Additional questions complete a comprehensive “review of systems.”

Initial identification of provisional problems. Identification of provisional problems is the first major step in implementing a problem-oriented approach to patient management, which is at the heart of this invention. Based on the information gathered in the screening section, one optional approach implemented is CarePrep is to first identify provisional problems. For example, complaints of abdominal or chest pain or discomfort are preliminarily categorized to facilitate further characterization, as outlined below:
1. Screening questions about known problems, such as heartburn, acid reflux, or angina.
2. Screening questions to elicit common symptoms such as bloating, distention, fullness, gas, or rumbling.
3. Screening questions about abdominal and/or chest pain and/or discomfort. If patients have these common symptoms, then they will be asked if they have any pain or discomfort in addition to these symptoms.
4. Identify the defining key features for symptom complexes (Table 3)
5. Based on this screening information, provisional problems or symptom complexes are identified (see Table 5 for a partial list). Identification of these problems is established by implementing simple Boolean logic to meet criteria established by an expert panel. Implementation of Boolean logic is in a flexible format that supports continual refinement.
6. Assign a provisional problem name linked to an ICD-9 code.

TABLE 5
Partial List of Provisional Problems for Evaluation of Common
Gastrointestinal, Pulmonary, and Cardiac Conditions

Heartburn: burning discomfort under breastbone that usually radiated
to throat
Acid regurgitation: regurgitation of burning or bitter fluid into throat
Angina or exercise-precipitated chest, neck, shoulder or arm discomfort
or pain
Pulmonary pain: increased pain or discomfort with coughing or deep
breathing or association of chest pain with coughing or shortness
of breath.
Chest or abdominal wall pain: associated with local tenderness or
increased with movement
Other chest pain or discomfort
Indigestion: upper abdominal discomfort occurring during or soon after
meals usually associated with belching, bloating, or a sensation
of stomach (upper abdominal) fullness
Acid dyspepsia: ulcer-like burning discomfort or pain occurring on an
empty stomach and relieved with food, antacid, or antisecretory agents
Irritable (or sensitized) bowel: discomfort or pain associated with a
change in bowel pattern or urge to defecate and/or relieved with
decompressing the colon
Abdominal distention or bloating
Gas or rumbling
Other abdominal discomfort or pain
Diarrhea
Constipation
Anorexia: loss of appetite or weight loss
Nausea and/or vomiting
Dysphagia: difficulty swallowing
Odynophagia: pain with swallowing

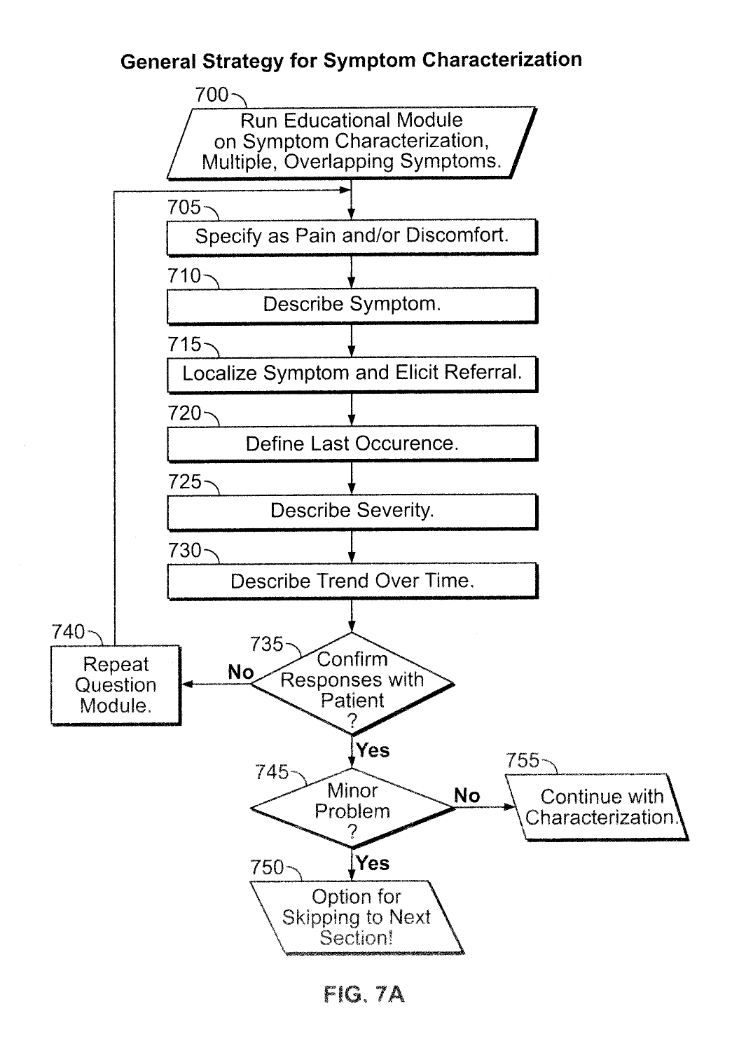

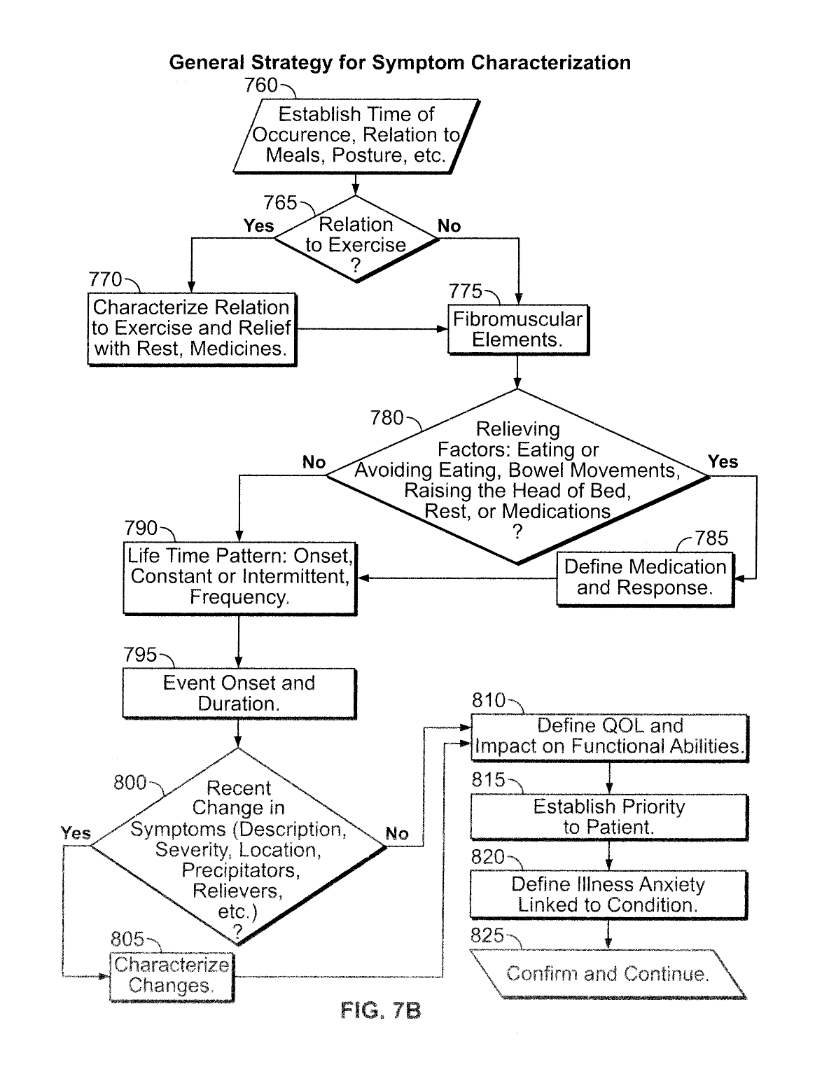

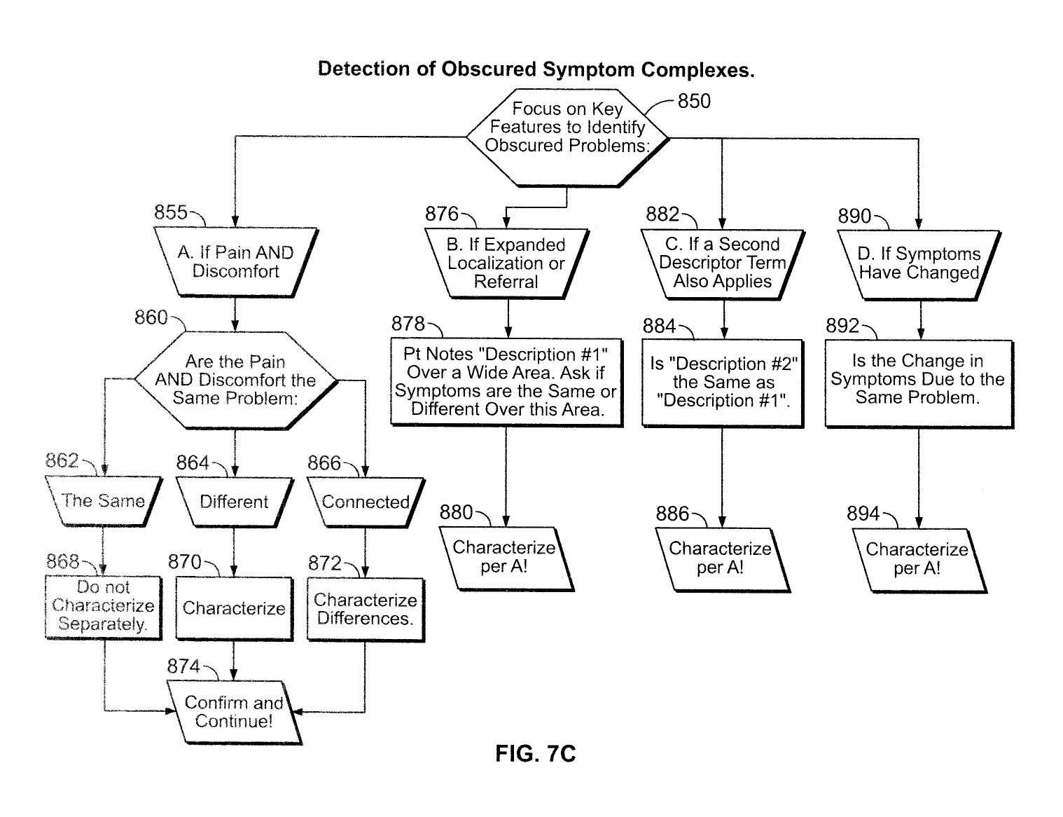

Characterization and discrimination of symptom complexes into provisional problems. This process is critical to complete the discrimination of provisional problems that will be presented as the CarePrep problem list for clinician consideration. If the patient presents with only one pain or discomfort, it will be characterized as indicated in FIG. 7A, where the opening screens are a brief educational series on the characterization of pain using key features (Table 3) and on the likelihood of multiple, overlapping symptoms, block 700. As depicted by the screens in FIG. 5D, patients are then asked if they describe their symptom as a pain, a discomfort or both, block 705, as many patients are unwilling to call a symptom a pain when discomfort is the word that fits for them. To describe the pain or discomfort, patients are presented with several adjectives to select among, block 710. A body localization chart is displayed on block 715 in which they touch the areas where they experience the pain or discomfort; sequential touches change the color to indicate severity of the pain in that region. The body localization figure is divided into center, right, and left segments in the upper and lower chest, and upper, mid and lower abdomen. Other regions of the body are also segmented to indicate the location of pain. Alternatively, the patient will be given test options to describe the location of their symptoms. The patient is then asked when they most recently had the pain, to describe the severity, and trend over time (better, worse, same, or varying), blocks 720, 725, and 730. In addition to characterizing the problem, these questions identify minor problems (no recent occurrences, minor severity, and/or improvement or disappearance over time). The responses are confirmed with the patient, block 735. If criteria indicate that the problem is minor, the patient is offered the option (block 745) of skipping to the next section of characterization, block 750. If symptoms are not minor, the patient continues, block 755.

Additional characterization questions continue in FIG. 7B, where the times of occurrence and relation to activities, posture, sleep, meals, and exercise are established (blocks 760 to 765). If a relation to exercise is indicated, then the degree and consistency of occurrence and relief with rest and medication is sought because these data can implicate a cardiac etiology (block 770). Fibromuscular elements are sought in block 775, by asking such questions as whether there is local tenderness or precipitation by tightening the involved muscles, taking a deep breath, bending, or twisting. Cross referral and sensitization is common due to the convergence of the nerves to the viscera and body wall in the spinal cord and brain; visceral disease can frequently be associated with fibromuscular tenderness. Identifying a fibromuscular element is very helpful, often serving to clarify otherwise confusing pain and simplify the diagnostic process.

Relieving factors are asked about, since this information can provide important clues to diagnosis and appropriate therapy. Questions are asked about effects of rest, posture, eating or avoiding eating, and medications, block 780. Branching screens define specific medications, compliance and response, block 785. Additional questions are asked about the pattern over time, frequency, and onset and duration of episodes (Blocks 790 to 795). Finally in blocks 800 and 805 any changes in severity, description, location, and timing are sought and characterized because these changes can also provide important clues to the nature of the problem or to new problems. With the problem now defined, QOL measures are applied that determine the degree of impact on daily functions, such as walking, exercising, basic activities or household chores, working, socializing, or sleeping, block 810.

Eliciting an obscure problem. It is common for patients to have a symptom complex that obscures a second problem. Identifying this second problem may facilitate the management process. The invention implements several mechanisms focusing in key features to identify obscured problems (block 850 in FIG. 7C). These steps are implemented at the conclusion of a characterization sequence, block 825 (FIG. 7B).

When patients are asked if symptoms represent a pain, a discomfort, or both, the choice of pain AND discomfort may indicate overlapping symptom complexes. For example, a pressing chest pain may be noted with exercise due to angina along with a dull, continuous discomfort due to a chest wall muscle ache. The patient might not know these are separate until they are teased apart. When patients report both pain AND discomfort (block 855), they will be asked if these represented problems that are the same, different or connected (Block 860). If symptoms are the same, no further characterization will be performed, block 868. If symptoms are different, block 864, detailed characterization (Blocks 705 to 820) will be presented. If symptoms are connected (related, but not the same), the differences will be characterized (block 872).

Localization may also provide a clue. Symptoms that are localized in broad areas or referred to other regions (e.g., chest pain that is also felt in the abdomen) may represent expanded referral of a single problem (a common phenomenon especially with functional gastrointestinal disorders) or two discrete disorders. When localization suggests expanded distribution block 875, the patient is asked to focus on the key features (how the pain feels and when it comes and goes) to decide if symptoms in these different regions represent the same or different problems, block 878.

When describing symptoms, the patient can select more than one adjective (e.g., burning, pressing, aching, etc.). If a second term is chosen, block 882, the patient is then asked to consider whether the use of this second reflects the existence of a different or connected problem, block 884.

If a patient notes that her symptoms have changed, block 890, she is asked if the change in symptoms represents a change in pattern or key features, block 892. Is the changed symptom different, connected, or the same.

After patients complete characterizing the problems identified in the screening questions, they are asked if they have any other pain or discomfort. Instances of the importance of this type of distinction are offered in the examples section.

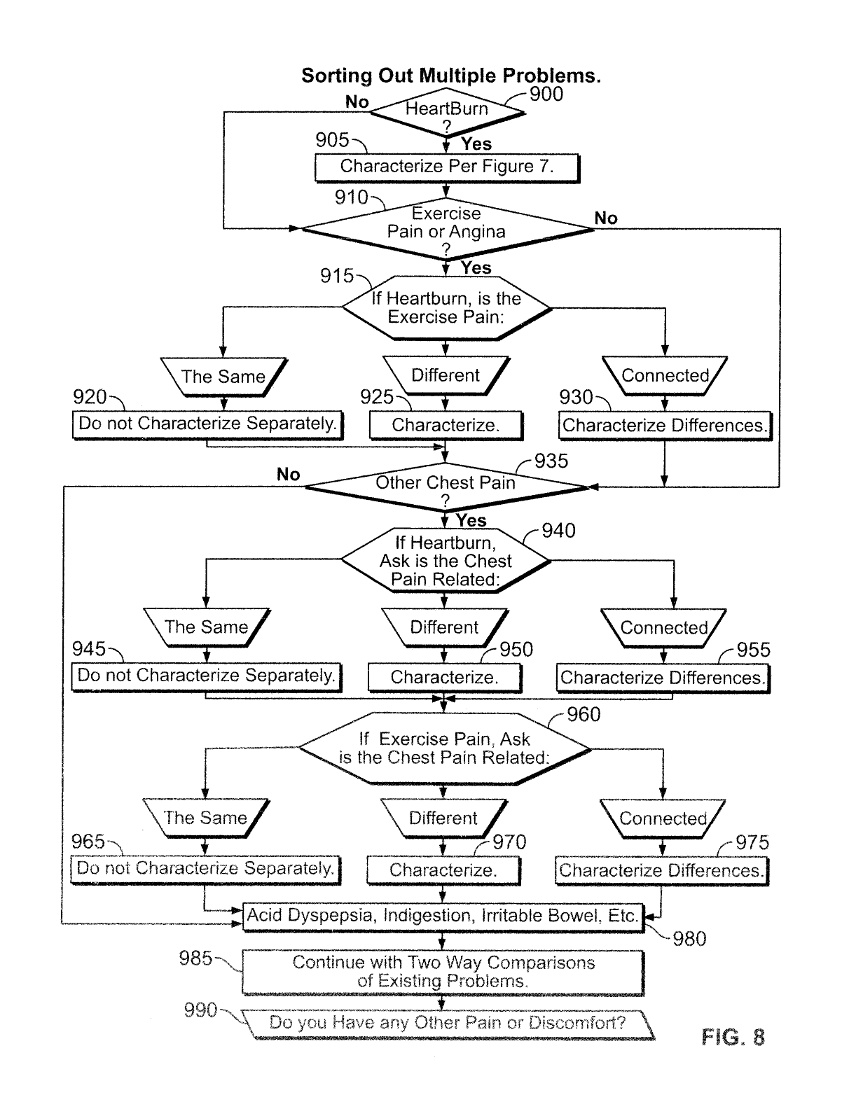

Discriminating multiple, overlapping provisional problems. Multiple, overlapping symptom complexes present a common challenge: they may be separate problems or they may in fact represent the same underlying process. These distinctions have a substantial impact on the diagnostic and therapeutic process. The invention is designed to improve the patient's ability to accurately describe multiple, overlapping symptom complexes and the clinician's ability efficiently work with this information. If there appear to be multiple candidate provisional problems, several steps are involved in dealing with discriminating overlapping conditions. Each potential provisional problem (examples are listed in Table 5) is systematically characterized following the general format outlined in FIGS. 7A, 7B, and 7C:
1. Patients often cannot distinguish different symptoms until they have thought about the key features (Table 3). The strategy to dissect these problems is to ask the patient about the key features of each individual problem on its own and in relation to the other defined problems. This process is iterative until all problems and their interrelationships are defined. The logic of this process is depicted in FIG. 8. For example:
   If the patient screened positive for heartburn, block 900, then this symptom is characterized, block 905. If the patient screened negative for heartburn, screening variables for symptoms of exercise pain or angina are tested, block 910.
   If this test, block 915, reveals that both heartburn and exercise pain/angina are present, the patient is asked if these symptoms are the same, different, or connected.
      If the patient responds that these symptoms are the same, then the exercise pain is not further characterized, block 920.
      If the heartburn and exercise pain/angina are different, then the exercise pain is characterized in detail, block 925, using the strategy depicted in blocks 715 to 820.
      If the patient reports that these two symptoms are connected, then they will be asked which key features are different, block 930. In this case, only the features that differ will be characterized, branching through blocks 715 to 820.
   Logic continues at block 935, where the presence of another chest pain is tested.
      If no other chest pain is present, logic continues at block 960. However, if another chest pain is present, then the presence of heartburn is tested, block 940.
      If heartburn and another chest pain are present, the patient is asked whether the heartburn and this other chest pain are the same, different, or connected.
   Subsequent characterization, blocks 945, 950, and 955, depends on the answer (described above for blocks 920 to 935).
   Logic continues to test presence of exercise pain, block 960. If exercise pain/angina is present along with another chest pain, the patient is asked if exercise pain or angina is the same, different, or connected with this additional chest pain.
   These two-way comparisons continue until all options have been examined. To facilitate the comparison, variable text functions are utilized so that the patient is asked about the specific problem they reported in the previous section. From a patient's perspective, this seemingly laborious process is rather simple when presented sequentially with specific, unimodal questions and questions relevant to their symptoms. Other strategies of discriminating overlap may also be developed, tested, and implemented by the inventive system.
2. An additional strategy to distinguish symptom complexes is to analyze typical patterns in real time. If a given symptom complex includes features that are not typical of a single disorder, such as a chest pain that is worse with belching (typical of acid reflux) but is also worse with exercise (typical of angina), the inventive system highlights this apparent contradiction for the clinician's consideration during the patient evaluation.
3. The CarePrep analysis of symptom complexes may also reveal situations where symptoms apparently share features. Physicians will be informed of any apparent overlap. For example, if the patient has functional symptoms such as heartburn, indigestion, acid dyspepsia, and/or irritable bowel syndrome, this suggests the possibility of a widespread irritable gut. Although organic disease should be considered, this scenario is likely for functional disorders.

The value of attention to detail in history taking. The detailed history performed by the inventive system will improve clinical management.
1. Although many chest and abdominal symptoms are nonspecific and overlapping, they can provide highly valuable clues to the underlying diagnosis and provide a starting point for effective management.
2. If multiple or overlapping symptom complexes are present, the failure to tease these apart or to recognize relations between them impedes the diagnostic process. Recognizing discrete problems (the separateness of two problems that the patient initially groups together) may reveal important underlying disease processes. Likewise, recognizing overlap (the association of two seeming unrelated symptoms) may simplify the diagnostic process.
3. The computer-aided, back-to-basics process provides the information necessary to detect changes in symptoms. These changes may herald the emergence of a new problem that warrants clinical attention.
4. In addition, the information that is generated by this structured, consistent assessment will build a knowledge base on a large number of patients. This database will allow the implications of symptoms to be recognized in a timely manner to optimize patient management.
5. Patients are educated and activated to know themselves, their symptoms, and how to communicate them. As patients are educated to provide their doctors with more accurate information about their symptoms, the history will prove even more useful in facilitating the diagnostic process. Although one might be concerned that this would exacerbate perceptions of pain, in reality, illness anxiety is usually alleviated by this educational process.
6. The inventive system provides the benefits of this detailed history for clinicians who may lack the time and skills to extract this history themselves. In the process, clinicians are trained to refine these skills that support patient-centered care.

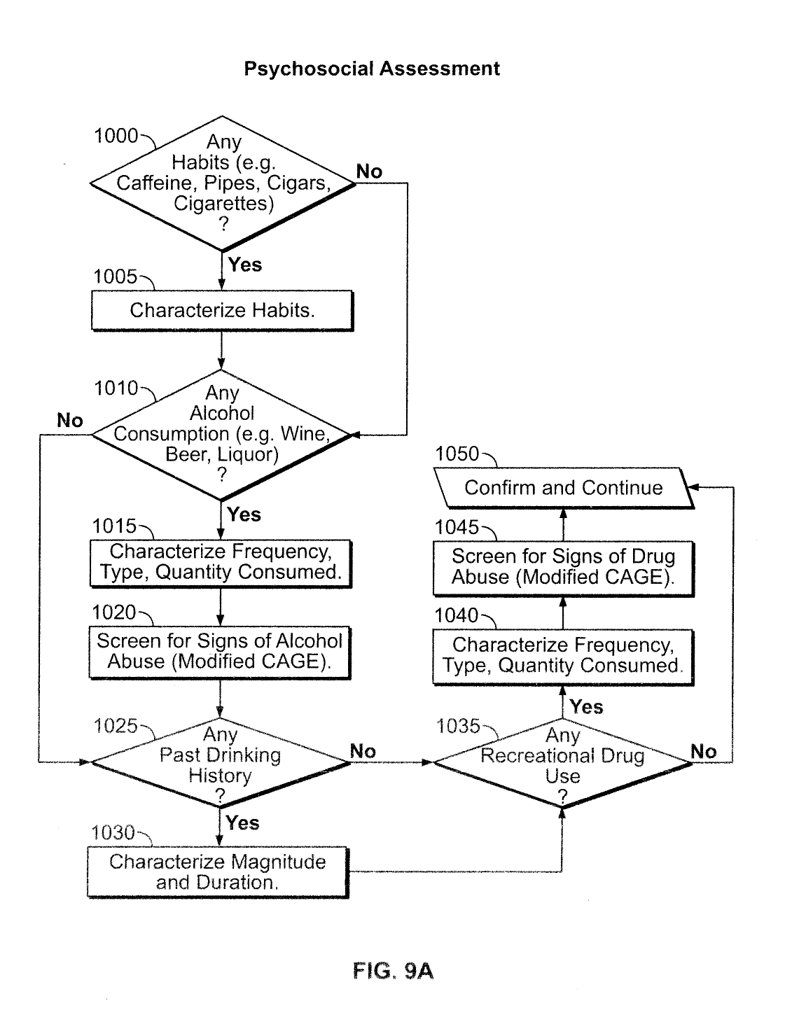

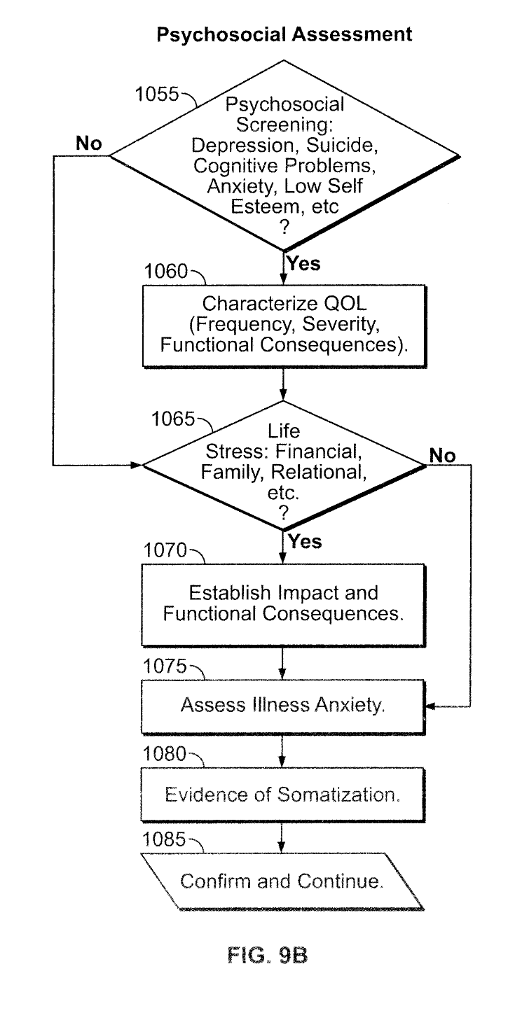

Psychosocial screening assessment. Habits and substance use and abuse are screened for by the inventive system (FIG. 9A). For drug and alcohol consumption, one option for questioning is to allow patients to indicate alcohol consumption frequency from never to every day, block 1010. Quantities of wine, beer, and liquor consumed are then sought, using branching question sets to avoid posing irrelevant questions, block 1015. Questions are then asked to determine if alcohol use disrupts the patient's life, block 1020. Questions are also asked about past drinking history, block 1025, since prior heavy alcohol consumption has important health implications. A similar sequence of questions is asked for drug abuse, blocks 1035 to 1045.

Elements of further psychosocial assessment are depicted in FIG. 9B. Screening for common psychologic comorbidity is conducted (e.g., domains of depression, anxiety, low self-esteem, PTSD, etc.), block 1055. Questions are displayed on screens that allow each response item to have up to 5 choice options, such as never, rarely, a little, some, and always (FIG. 9.1). These choice options can be scalar or categorical to measure how frequent and troublesome these domains are for the patient. It also allows patients to share more meaningful information about their symptoms without being pigeon-holed by limited binary responses, such as yes/no. Psychologic symptoms are grouped into domains, such as depression; suicide; cognitive dysfunction; anxiety; and low self esteem. Each domain comprises a scale with validity and reliability measures; the inventive system analyzes patient responses on the scale for each domain in real time and reports this information to the clinician. When a patient scores moderate or high values on the scale for a particular domain, the degree of distress and functional impact is assessed, block 1060.

Life events that are perceived as stressful (e.g., trauma and illness, relationship problems, family problems, housing-related stress, financial pressures, legal problems, and work-related stress) are also assessed using scalar responses that indicate the degree of distress caused by the problem, block 1065. In addition, the impact and functional consequences of stressful situations are established, block 1070. Patient concerns about their illness, such as the presence of a serious underlying disease, the risks or ordeal of required testing or treatment, or poor future outcomes, are assessed in the sequence on illness anxiety related to specific conditions, block 820, or in general, block 1075. Recognizing and addressing these psychosocial issues has a significant impact on outcome of the therapeutic process. As described previously, the review of systems (FIG. 6A) captures physical symptoms in several organ systems that may suggest somatization, a psychologic condition with the high reporting of physical symptoms that often distracts clinicians, until recognized. At test block 1080, tests are performed to determine if patterns are suggestive of somatization. Symptoms that suggest somatization are recorded and presented to the clinician in the CarePrep patient assessment report. Responses are summarized and presented to patients for confirmation, block 1085.

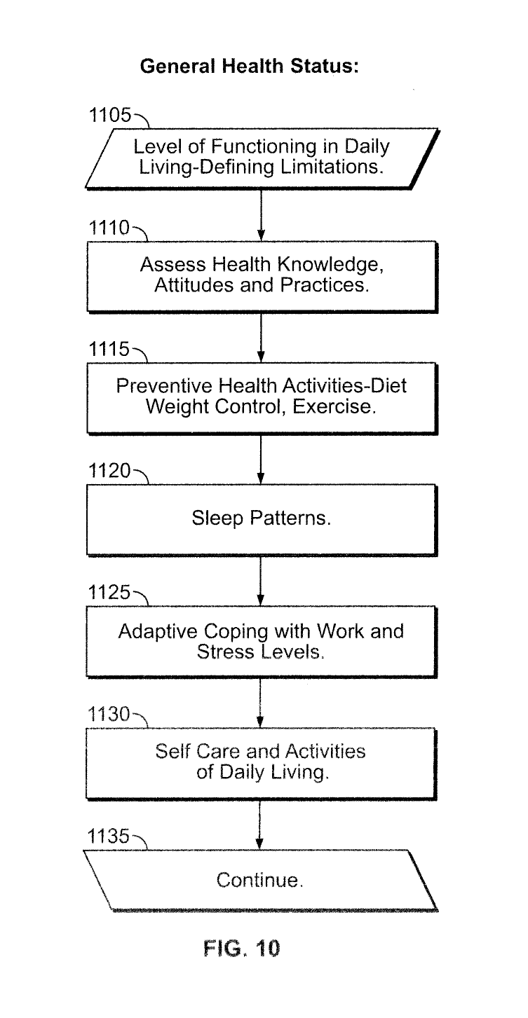

Logic continues in FIG. 10, to complete the medical history with questions about general health status (1100); level of functioning and activities of daily living (1105); health attitudes and expectations (1110); preventive health activities including diet, weight control, and exercise (1115); coping activities for stress (1115); and problems with self-care (1130). Additional information is collected on past medical history; medications and compliance behavior; allergies or untoward reactions to medications; surgeries, accidents, or injuries; other medical problems; and family history (not illustrated).

Formulating the agenda for the patient-clinician encounter. As the assessment proceeds, the invention formulates a provisional problem list based upon expanded criteria, adapted from those outlined in Table 5. As each subspecialty area is developed (Table 2), a set of Boolean criteria are created for each common symptom complex within the area. A mechanism has been established to test these criteria in three subsets (e.g., all of symptom set x, any of set y, and none of set z). As assessment process proceeds, these criteria are tested. Problems are called “provisional” because the invention is not currently designed to make firm diagnoses, but rather to gather and process relevant, accurate patient data that allows the clinician to designate problems or make diagnoses. The provisional problems that have been identified will be presented to the patient, asking whether review of these problems during this clinic visit is of high, medium, or low priority from their perspective. In addition, certain system criteria apply that automatically elevate some problems to high priority based on clinical importance, such as new onset chest discomfort, progressive difficulty swallowing, or blood in the stool. The problem list is presented to the clinician in the order of priority. Associated symptoms and detailed characterization are summarized using a grammatical format with the variable text functions.

Patients are also asked if they have additional issues to address. Specific options are presented, such as problems with medications or concerns over future testing, treatment, or prognosis. Finally, patients are asked for any other questions, issues, or expectations from the visit. This patient input can be captured in a variety of formats, including recording way files using the microphone system (block 90, FIG. 1) or keyboarding by the patient or clinic staff.

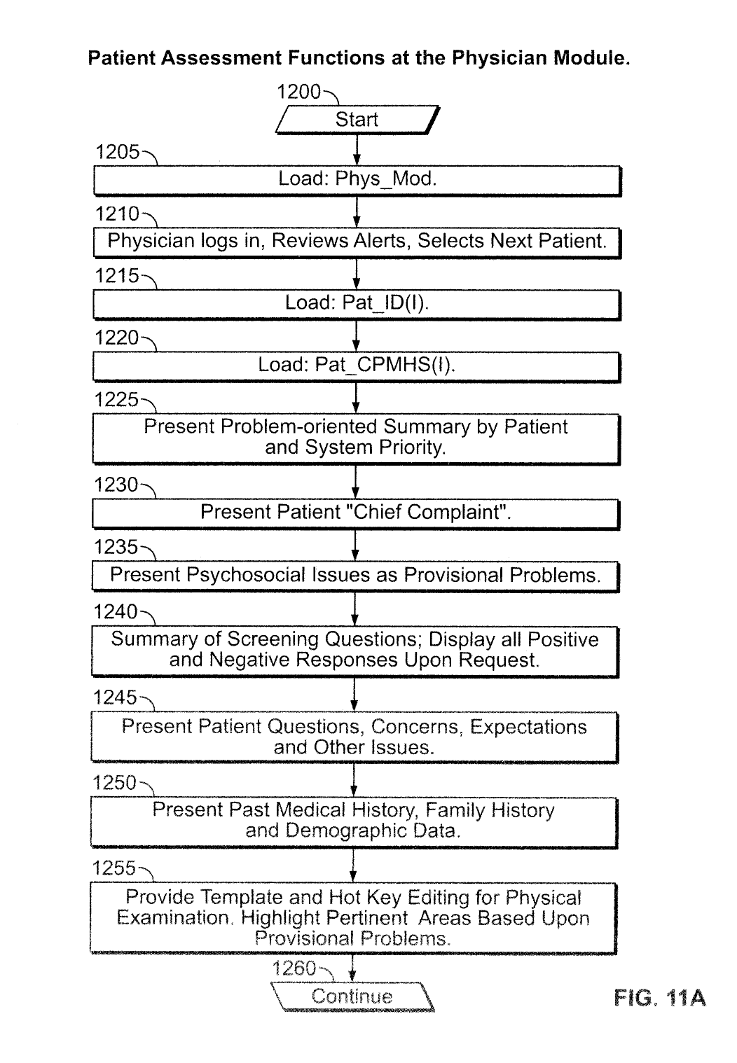

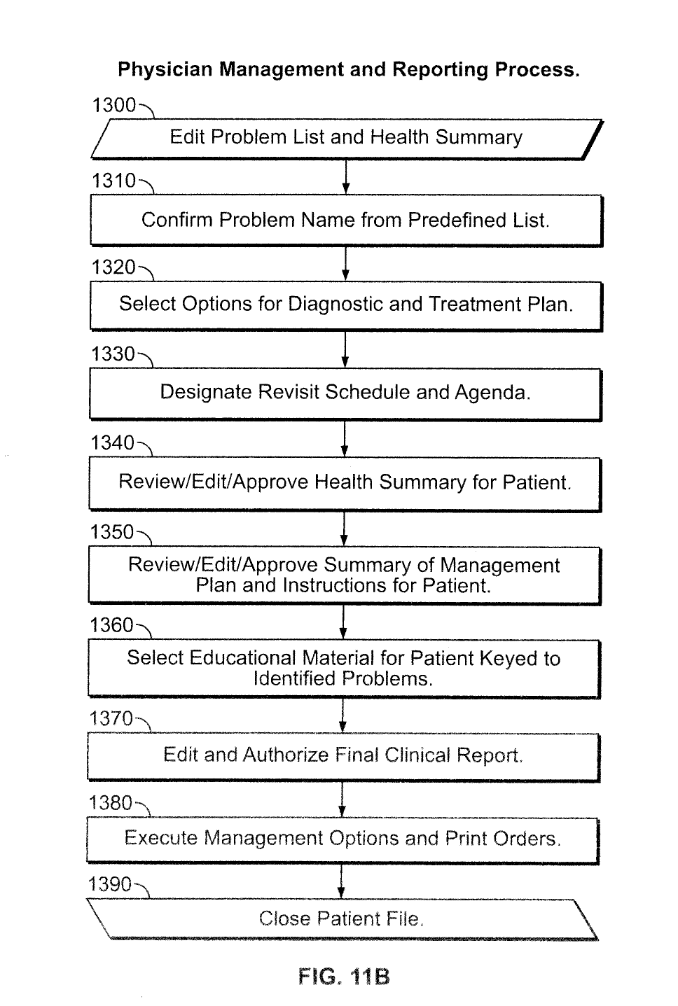

Use of the Clinician Module. Before or at the outset of the clinic visit, the clinician accesses the CarePrep clinician module over the Internet or local network to review the patient information as collected by the invention, as described above in the section entitled “The clinician module: the problem-oriented CarePrep record.” Clinicians use it to view a summary of patient data, access details, and provide their updates, impressions, and plans. Logic for the clinician workstation is depicted in FIG. 11A. The clinician logs on, reviews notices regarding flagged problems or alerts, and selects the patient to be seen, block 1210. After selecting the patient, patient data, block 1215, and the problem-oriented health summary, block 1220, are loaded. The clinician can then review the alerts for this patient, the summary of symptom, psychosocial, behavioral, and quality of life issues, each of the relevant problems and the chief complaint, blocks 1225 to 1235. The clinician can set filters to display all related information on each provisional problem, or display just the name and brief summary. The display includes summaries of screening questions; primary data can also be displayed at will, block 1240. In instances when the patient has been seen previously, additional information will be available for each problem, as indicated in Table 4. The workstation display also includes the patient's questions, concerns, and expectations, block 1245. Past medical, family, and social history are also displayed, block 1250.

A template is also provided for the physical examination, with prompts for findings that may be important based upon the provisional problems. Hot key responses facilitate rapid reporting, block 1250 (FIG. 11A). Facility for computerized voice transcription will be available as an option for clinicians.

After completion of the physical examination, the clinician reviews and edits the problem list, block 1300 (FIG. 11B). Physicians can accept or modify problem names, block 1310, which are drawn from a predetermined list developed for each subspecialty by an expert panel. This index of standardized problem names is available for ready searching; hot keys are implemented so that the standardized problem name is displayed once a defining number of characters have been typed. Problem names are compatible with standardized nomenclature such as SNOMED, and linked to ICD-9 codes. This compatibility of CarePrep data assures ready communication with other information systems and useful for populating encounter forms and JCAHO-required problem lists.

Once problems are defined, management options linked to these problems (drawn from defined treatment guidelines) can be optionally displayed for selection, block 1320. Thus, the clinician is given full control of decisions, but these decisions are facilitated by a menu of guideline options and then captured in the database. Management options include the following:
1. diagnostic tests (blood tests, procedures, radiography)
2. subspecialty referrals, for example, to gastroenterology, cardiology, gynecology, or surgery
3. other referrals, for example, for nutritional assessment, psychosocial/psychological, stress assessment and intervention, or somatic therapy
4. therapeutic options including indicated drugs (with dose, frequency, duration of therapy, side effects)

Data such as the indications, contraindications, preparation, risks, and benefits can be accessed for the selected diagnostic tests or treatment options. When a clinician writes or accepts a drug from the menu, default settings for items such as standard dose are displayed for selection or editing.

The clinician then selects the timing for revisits and the agenda of what will be done, block 1330. Follow-up scheduling could include plans such as the following:
return for evaluation of response to therapy in “x” weeks
discontinue medications at given time
repeat endoscopy and biopsy in “y” weeks, or
perform follow-up blood studies in 12 months.

Patients are optionally given personalized instructions and education material when they leave the clinic. The clinician selects this material for the patient from a menu of prepared text and graphics, block 1360:
a health summary prepared for the patient based upon the identified problems and symptoms
instructions for diagnostic studies, procedures, treatment plans
instructions for self-care and lifestyle measures
the agenda for future visits and consultations
educational materials for identified problems

The clinician then reviews, edits and authorizes the final clinical report and execution of management orders (blocks 1370 and 1380).

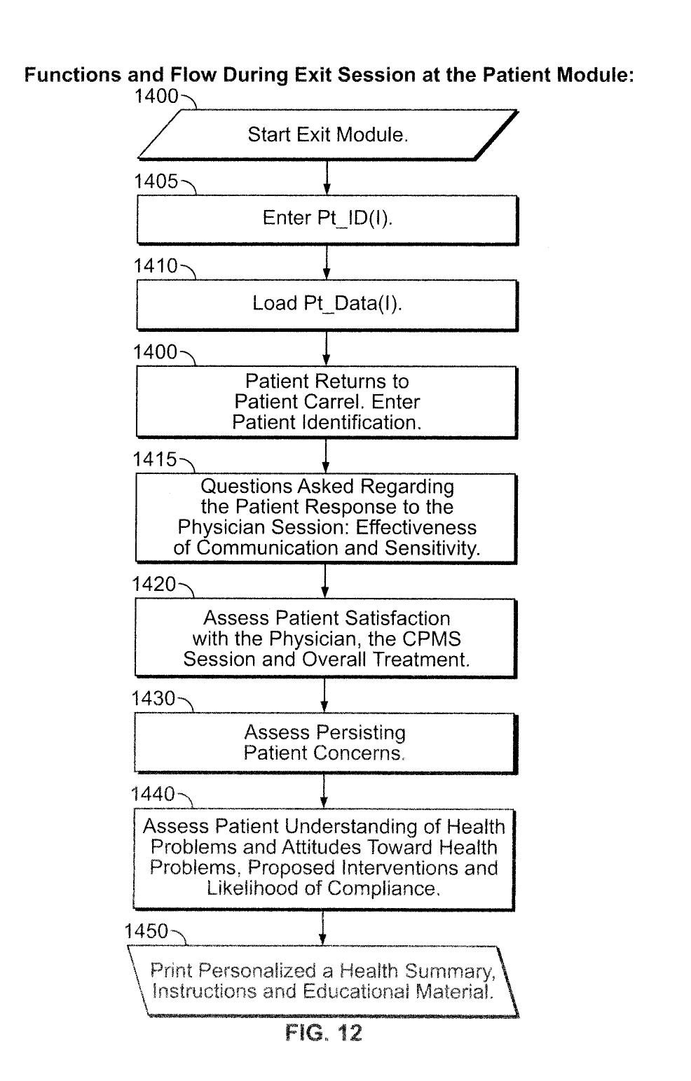

Exit assessment. After the clinician visit, the patient optionally returns to the CarePrep patient carrel for the exit assessment or can do this exit assessment from home over the Internet. This sequence includes questions on the patient-clinician encounter, attitudes towards compliance, illness anxiety, and any outstanding health-related questions or concerns (Table 6 and FIG. 12). Illness anxiety and health attitudes can be compared to the initial assessment to find the effect of the clinician encounter on the patient's health concerns. A microphone or keyboard can be used by the patient or staff to enter the patient's persisting questions or health concerns. Finally, the patient is given a printed health summary, including their problem list, clinician and follow-up instructions, personalized health education materials, and a reference on local resources, such as further instruction, counseling, support groups, websites, and hotlines.

The inventive system uses exit assessment data to further support patient-centered care by providing individualized feedback to the clinician on elements of the patient-clinician interaction and patient health attitudes. These data are collected from the patient and fed to the clinician on a per encounter basis. This information serves to educate clinicians on the impact of their actions, effectiveness of their communication, and patient response over time.

TABLE 6
The Exit Assessment

| | |
|---|---|
| 1. | Assess the patient-clinician encounter: interaction and communication. Questions include: |
| | Did the clinician listen to the patient? |
| | Did the patient feel heard and understood by the clinician? |
| | Did the patient understand the clinician? |
| | Did the clinician address the patient's concerns? |
| | Does the patient understand their condition and treatment as described by the clinician (e.g., |
| | instructions for procedures, use of medications, other treatments, etc.)? |
| | Was the patient involved in negotiating a reasonable treatment plan (e.g., testing, prognosis, |
| | treatment, self-care, etc.)? |
| | Was the encounter rushed? |
| | Were the patient's expectations met? |
| 2. | Assess compliance attitudes. Questions include: |
| | Does the patient understand the treatment prescribed? |
| | Does the patient think the treatment is important? |
| | Does the patient think the treatment is reasonable? |
| | Does the patient foresee barriers to compliance? If yes, what are the barriers (e.g., financial, |
| | time-related, lack of social or technical support, lack of motivation, etc.)? |
| | Does the patient intend to comply? |
| | Does the patient want further instruction? (If yes, the patient has the option of running |
| | through an appropriate education module or clinic staff may be alerted) |
| 3. | Assess illness anxiety (adapted from psychosocial question sequence). |
| 4. | Capture open-ended patient feedback. |
| | Does the patient have any outstanding questions, concerns, or comments? |

Completion of the exit assessment concludes patient interaction with the inventive system for this clinic visit. However, patients may access CarePrep in the interim from home via the Internet or at the provider organization for updating the status of their symptoms, reporting new symptoms, completing the assessment, or doing health education sessions. If CarePrep computerized analysis of new patient information reveals a condition in need of prompt attention, the patient is instructed to seek care at the end of their CarePrep session. The patient's responsible clinicians are also notified of the patient's updated status via e-mail or an automated voice message or page generated by the inventive system. In any environment, early detection of problems improves the quality of care; in capitated environments in particular, this translates into lower overall health care costs.

Revisit strategy. The revisit sequence is called up when a patient who has previously interacted with the inventive system in a clinic setting (or online) returns to the clinic. The revisit module is loaded and started at block 1500 (FIG. 13), based on the results of test 315 (FIG. 5A). The data for the returning patient are loaded, block 1502, along with the revisit agenda generated by the clinician at the conclusion of the previous session, block 1505. The patient is offered an orientation to the revisit process, block 1510. The patient's reason for the revisit is then sought (block 1515). Several response options are offered including items such as new symptoms (block 1520), change in status, concern or follow-up regarding a known problem (block 1540), or routine visit (block 1545).

The patient is also asked if she initiated the revisit or if the clinician requested the revisit. The patient's perceived reason for the visit is compared to the clinician's revisit agenda for follow-up care. This comparison provides a measure of care-seeking behavior. Understanding this behavior on a routine basis can be used to develop strategies to improve the overall cost-effectiveness of care.

If new symptoms are detected, the nature of these are sought and characterized (block 1525), branching to a specific module, as necessary, block 1530.

If the reason is follow-up or change in status of a known problem, or a routine follow-up evaluation, the patient's previous problem list with brief descriptions is presented, block 1550. The patient is asked if this problem list is accurate, block 1555. If incorrect, the patient can branch to characterization screens to correct errors, block 1560. When problems are confirmed, changes in status of each problem will be sought, block 1565. For example, the patient will be asked: “In the time since your last visit (the inventive system will substitute the exact period of time), is your burning, mid-chest discomfort better, worse or unchanged?” Change will be characterized, block 1570, seeking better insight into the nature of the symptoms or identifying new problems obscured by association to previous problems. Other approaches to assessing symptom status and change will also be explored, such as presenting prior answers to them for updating or probing for symptoms in the areas that were positive previously.

Patients are also asked about compliance with prescribed treatments and medications, block 1575, and satisfaction with that management. If the patient reports that she did not comply with any aspect of the treatment, reasons for noncompliance are sought.

Changes may indicate cure, palliation, progression of an underlying disease process, or effects of other life events. If symptoms are better or gone, reasons for this positive change are sought, such as medication use or other treatments, just went away, changes in patient health behavior or life situation, or other factors, including psychosocial or stress elements. Returning patients are asked if they sought care from other health care providers for any reason during the interim period. If yes, reasons for seeking other care (e.g., clinician referral to specialists or for procedures, desire for alternative care, etc.), types of care, and types of providers are recorded. These data will be valuable in designing plans for individual patients or population subgroups, aggregated based on variables of interest such as demographic characteristics or health attitudes.

After pursuit of the primary reasons for the return visit and determining status of known problems, the system loads the revisit screening sequence, block 1580, derived from the triage and screening strategy described previously (FIGS. 5 and 6). In this process the patient will go through an abbreviated review of systems and psychosocial screening to elicit new symptoms or changes developing during the interim period, block 1585. Any symptoms that are uncovered will be characterized, block 1587, in a similar fashion to that described previously.

The patient is asked for questions or other issues to be discussed with the clinician, block 1590. Following completion of the revisit session with the inventive system, the CarePrep database is updated with new patient information and a problem-oriented report is prepared, block 1595. This report is immediately available for clinician review at the clinician workstation using a format designed for clinician editing. After the clinician revisit, patients return to the patient carrel to complete the exit assessment.

Computer implementation of CarePrep process. Described herein is the design of computer system and its basic components that implement the functionality of the CarePrep system to facilitate and measure optimized clinical process. The computerized system that embodies the CarePrep concepts is a computation device that provides screen development facility (CarePrep screen editor), script development facility (CarePrep script editor), and script interpretation-playback facility (CarePrep player). This modular design provides flexibility and scalability for computerized support of patient assessment, quality of life measurement, clinician process, assessment of patient satisfaction and response to therapy, and capture of integrated, encounter-based process and outcome measures (i.e. linked to specific episodes of provider-patient encounter).

The CarePrep system does more than present question screens and collect data. What separates the CarePrep system from a simple question screen is the scope and integration of the multifaceted computer support of the CarePrep clinical process. The ability to support discrimination of several overlapping problems, branch through question sets, and create relevant output using flexible logic systems and provide specific feedback to patients in bulleted phrases or grammatically-coherent format are essential features. The overall modular design supports another key feature of providing capacity to scale up the process to handle a wide range of medical disorders and facilitate editing and refinement of question screens and script files.

The CarePrep concepts for patient assessment could also be embodied in other systems: clipboards, paper, and other computational systems, but this would be laborious and would not provide the integrative functions achieve with the computer system. Programs written in a variety of languages and using a range of computer systems (PC, Apple, or other type of personal computer, netbook, minicomputers, mainframes, or any other computing device capable to network access) could be used to support the CarePrep process.

The CarePrep system further comprises a clinician-editor's tool-kit having four distinct “tools” used by the clinician-editor to create clinical applications. Other tools of similar or equal scope will be apparent to the skilled artisan after having the benefit of this disclosure. The first tool is the script editor for supporting creation of scripts that control the flow of the presentation to the patient, screening for potentially important symptoms, data collection, provisional problem identification, and reporting to the patient and clinician-user. The script editor uses an advanced point-and-click graphic user interface (“GUI”) which shields the clinician-editor from the complexi-ties of the embedded presentation language, provides debugging facilities, eliminates syntactical errors and streamlines the learning curve. However, other interfaces could be utilized to accomplish the same goal.

The second tool is the screen editor and screen definition language. The screen editor is used by the clinician-editor to design data collection screens and screens for presentation of information regarding use of the system or health issues, “reward” displays to encourage participation, feedback to the patient, and the like. Screens handle their own data capture operations, thereby removing considerable complexity from the controlling script. Screens can be reused at different points in a script with context-specific content. A point-and-click GUI handles all interaction with the embedded screen definition language.

A glossary editor is the third tool for supporting parallel scripts adapted for patient characteristics such as age, gender, educational level, and ethnic background. The glossary editor permits the clinician-editor to design multiple content models of a given script. For example, initial screens can determine the patient's age and level of education and then select an appropriate glossary of content blocks. Targeting questions to subgroups is more effective than utilizing broad-spectrum questions for all patients. Patients will find the process more relevant, motivating them to use the system. This facility is integrated into the internal presentation and screen definition languages.

The fourth exemplary tool is the pattern set editor. Problem identification and provisional diagnoses are defined in terms of multiple, overlapping patterns of patient responses. The inventive CarePrep system employs an innovative pattern recognition engine that supports extremely flexible views of symptom data. The pattern set editor can be most easily implemented using a screen format with list boxes for each of the defining conditions (e.g., ALL of the criteria in one list, ANY of the criteria in a second list box, and NONE of the criteria in the third). This simple interface permits the clinician-editor to define complex patterns within a large universe of possibilities. This simple presentation using a GUI interface with list boxes allows the clinician-editor to refine the criteria for identifying symptom complexes or testing other criteria based upon experience with patients and clinician-users. Other methods for efficiently and flexibly implementing Boolean logic are available through the script itself.

A preferred presentation engine (the player) runs in the corresponding patient carrel computer terminal and is summarized herein. Internally, a master interpreter controls the execution of clinical applications comprising scripts, screens, glossaries and pattern sets. Specifically, the interpreter performs the following functions:
1. displays screens (with internal multimedia elements);
2. analyzes patient responses to execute branching, context-sensitive scripts;
3. applies selected demographic-specific glossaries;
4. collects patient response data via script commands, screens, and inferences;
5. manages data variables and database updates;
6. uses pattern set targets within collected data to identify provisional problems;
7. utilizes instructions in the script to construct problem-oriented reports for patients and clinician-users;
8. manages storage, display and printout of reports; and
9. provides a debugging environment for clinician-editors during the development of clinical applications.

### Examples: Applying the System to Specific Patient Problems

The following examples are presented as illustrative modes of the invention but are by no means exclusive. One skilled in the art will no doubt be able to develop variations thereto and stay within the scope of the present invention after having the benefit of the disclosure herein. Although all patients are expected to go through the full system, only a few key steps are highlighted in the overview example for each patient.

### Patient 1: Assessing Overlap and Health Concerns

This example demonstrates evaluation of a patient with overlapping gastroesophageal reflux disease (GERD) and abdominal pain, confounded by marked health concerns over a recommendation to have surgery for his acid reflux.

Initial triage and screening assessments. This patient is new to the system, so he went through the entire screening sequence.

Screening for chest and esophageal symptoms revealed a history of heartburn and a corresponding burning substernal pain, block 450. No other type of chest pain was noted (block 460-465).

The patient denied coughing or asthma (block 500); both symptoms can complicate acid reflux. He also noted no difficulty swallowing (block 550).

Screening for abdominal symptoms revealed abdominal discomfort that was present in a pattern that initially confused the patient. He responded to the screening questions that he did have an upper abdominal bloating discomfort and fullness immediately after meals. He also reported that abdominal discomfort that was associated with a change in bowel pattern and relieved with evacuating his colon (blocks 605 and 615). Additional screening questions documented diarrhea alternating with constipation and no blood in the stool (Blocks 650 and 660).

Detailed Characterization of Provisional Problems, Sorting Out Overlap, and Clarifying the Interrelations.

Detailed characterization of bowel function revealed diarrhea alternating with constipation that had been present for three decades. There was minimal change in the pattern and these specific symptoms were of modest severity from the patient perspectives (Blocks 655, 665, 670).

Detailed characterization of his chest discomfort was then performed (blocks 700-820). The discomfort was burning in nature and substernal in location. Systematic questioning clarified that symptoms were found only after meals, during the day, and not at night. There was no relation to exertion and there was a moderate response to drugs that inhibit acid secretion. System queries established that these symptoms has been worse recently (block 730) and only moderately responsive to therapy (block 780). Quality of life measures were then explored and linked to each of these problems, allowing the severity and frequency of symptoms to be determined (block 810). Disruption of the patient's ability to perform functional activities of daily living was then established. These quality of life measures allow quantitative assessment of the functional impact of these symptoms, which is used as a baseline to measure response to a given management strategy. The substernal localization, radiation to the neck and relief by anti-secretory agents led to a firm identification of acid reflux. This pattern was summarized for the patient for the purposes of confirmation. The CarePrep Boolean logic recognized this pattern of upright, daytime reflux based on daytime, post-meal, but not nighttime symptoms.

Since the patient has an acid-peptic disorder, detailed questions were asked about use of aspirin and other non-steroidal antiinflammatory drugs (both over-the-counter and prescription) (block 760). These questions are often ignored in busy practice settings.

Abdominal symptoms were then characterized in detail. The Boolean treatment of initial screening data identified two possible provisional problems (Table 5): indigestion and irritable bowel syndrome. Boolean criteria for indigestion as a provisional problem include upper abdominal discomfort that occurs during and immediately after meals, is associated with belching, bloating or fullness (sensation of overeating). To minimize patient confusion, the first step is to distinguish this “abdominal discomfort that occurs during meals” from the patients “burning, mid-chest pain” that was previously characterized. The patient indicated that his “abdominal discomfort that occurs during meals” was different from his “burning, mid-chest pain.” This abdominal discomfort was then characterized using the strategy outlined in blocks 715-825. The patient had noted these symptoms had come and gone over several years. It was described as a bloating discomfort localized in the upper abdominal that came during or with 30 minutes after meals. Symptoms were worse after certain foods, fatty foods and onions in particular (block 760). This symptoms were summarized for the patients consideration and confirmation. These symptoms fit CarePrep criteria for “dyspepsia/indigestion.”

The next step in logic was to address the “abdominal discomfort that was associated with a change in bowel pattern and relieved with evacuating his colon.” Again, reference to this problem will be specific, so that the patient will have no doubt what is being references. Following the logic in FIG. 8, the next is to determine if this discomfort is different from the patient's “upper abdominal bloating discomfort that occurs during meals.” The patient responded that he was not certain if these problems were different, so that detailed characterization using the strategy in blocks 715-820 was presented to clarify the situation. These symptoms were long-standing and consistent CarePrep criteria established by an expert clinician panel for irritable bowel syndrome and identification of this pattern prompted generation of a provisional problem: presumed “irritable bowel syndrome.”

The patient was then asked if he had any additional chest or abdominal symptoms that were not covered and no additional complaints were reported.

Completion of the medical history and psychosocial assessment. Generation of problem list. Comprehensive screening for psychosocial comorbidity (block 1055), psychosocial stressors (block 1065), and illness anxiety (block 1075 and Table 7) revealed considerable patient concern about heartburn symptoms. The patient indicated concerns about the seriousness of his condition, the possibility of surgery, and potential consequences of the necessity for long-term treatment.

TABLE 7
Partial list of illness anxiety issues.
The inventive system assesses illness anxiety including patient
concerns regarding:

severity and consequences of the disease
no available cure
uncertain diagnosis
clinician did not understand the patient's concerns
clinician did not understand the patient's symptoms
necessity of further tests and procedures
risks of tests and procedures
need to take medication long term
medication risks, side effects, and dependency
need for surgery
risks and consequences of surgery
changes in lifestyle and behavior needed to comply with treatment or
promote good health
opportunity costs of treatment (e.g., time and financial costs)

General health status, health attitudes, and behaviors were then explored (blocks 1105-1130). This patient's psychosocial profile, general attitudes and health behaviors were positive, with no untoward health behaviors, such as smoking or drug abuse. Alcohol consumption was limited to occasional social use. However, the patient reported considerable trouble sleeping.

Issues presented to clinician in the clinician module. A summary of the patients provisional problems and other patient data were then presented to the clinician for review at the outset of the patient evaluation session (blocks 1225-1250). The patient's chief complaints, questions and health concerns are also highlighted for consideration by the clinician at the outset of the session.
Patient problems are presented in order of greatest concern to the patient, as determined when each problem was characterized (block 815). Clinically significant problems that are not prioritized by the patient are also presented. Characterization of symptoms, severity, frequency, and impact on quality of life are highlighted.
Relevant psychosocial domains are highlighted as provisional problems (block 1235). This is particularly important for illness concerns in this patient.
Review of symptoms, past medical history, and other patient data are presented for efficient review, so that the clinician does not need to spend time collecting these data.
The clinician has complete control of the problem list and can edit and restructure the list as necessary, thus reducing the time required to keep accurate and complete records.
A template is provided to facilitate the physical examination (block 1255). Key findings that should be sought are highlighted. For example, in this patient, a note would be added for the clinician to note if tenderness is present reproducing either the chest or abdominal discomfort.
The clinician then confirms the final problem list, block 1310. The confirmation entails selecting a final term with appropriate descriptors for each problem. ICD9 codes are assigned.
Treatment guidelines regarding diagnostic testing and management are then displayed for each final problem for clinician selection, block 1320. The clinician selects from available treatment options or enters their orders via keyboard or dictation.

The problem list. For patient 1, the problem list presented to the clinician might be appear as follows:

### 1. Gastroesophageal Reflux: Upright Pattern, High Patient Priority

a. Symptoms: burning substernal pain with radiation to neck and antisecretory relief.
b. Time pattern: symptoms have been intermittent for 30 years, but of increasing severity recently.
c. Complications: no evidence of local or respiratory complications.
d. Prior workup: patient states prior radiography and endoscopy were performed and results were normal.
e. Prior treatment: ranitidine: partial relief at 150 mg twice daily.
f. Comment: patient is concerned about problems from long term antisecretory medication use and risk of surgery.

Management Recommendations: (for Clinician Selection)
a. General instructions: instruct patient on lifestyle measures.
b. Medication:
   COMMENT: Patient with partial response to therapy and high concern over problem. Consider a change in management.
      Option 1:
         Add medication: omeprazole 20 mg qd and
         Discontinue ranitidine
      Option 2:
         Add medication: cisapride 10 mg qid.
         Continue ranitidine 150 mg bid
   ACTION PANEL:
   Current medication: ranitidine at 150 mg twice daily.
      Continue
      Discontinue
      Adjust dose
   New Medications:
      Omeprazole 20 mg daily, 30 min before meals
      Cisapride 10 mg qid, 30 min before meals and at bedtime

### 2. Dyspepsia: Indigestion Pattern, Probable.

a. Symptoms: upper abdominal bloating discomfort that occurs during and after meals. Worse with fatty foods.
b. Time pattern: longstanding, no change in pattern.
c. Prior workup: patient states prior radiography and endoscopy were performed and results were normal. No known H. pylori testing or treatment.
d. Prior treatment: ranitidine: no response

Management Recommendations (Click Desired Measures):
a. Reassurance: symptoms are longstanding, nonprogressive, and study were negative
b. Stress/anxiety reduction
c. Tricyclic antidepressants (amitriptyline 10 mg hs)
d. Dietary modification
e. Medication: cisapride trial: 10 mg qid before meals and hs
f. Re-evaluation and repeat endoscopy if symptoms persist or worsen.

### 3. Irritable Bowel Syndrome, Probable

e. Symptoms: crampy, gas-like mid-abdominal discomfort after meals. Relation to change in bowel pattern and relief with evacuation.
f. Time pattern: longstanding, no change in pattern.
g. Prior workup: patient reports negative barium X-ray study.
h. Prior treatment: none.

Management Recommendations:
g. Flexible sigmoidoscopy
h. Fiber therapy (e.g., Metamucil 1-2 tsp po qd-bid)
i. Tricyclic antidepressants (amitriptyline 10 mg hs)

### 4. Illness Anxiety

a. Symptoms: concern over diagnosis and prognosis.

Management Recommendations:
a. counsel patient regarding excellent prognosis
b. reassess upon next visit
c. consider referral for additional psychological evaluation if patient concerns about health are inappropriate or if patient does not respond to treatment.

### Advantages of the Inventive System for Patient 1:

Explanation and feedback is provided to the patient regarding symptoms. Symptom patterns are confirmed with the patient so that he becomes more fully aware of the symptoms and how to describe and communicate them to the clinician.
The overlapping presentation is discriminated. CarePrep elicits and discriminates the three symptom patterns that are likely to be confusing if not recognized. This facilitates clinician efficiency in collecting and interpreting the history.
The patient's enhanced understanding of his symptoms allowed the inventive system to generate a clear, detailed history for the clinician.
A clear description of symptoms lessens anxiety of both clinicians and patients, reducing the need for extensive work-up and improving the therapeutic response.
Important psychosocial history pertaining to illness anxiety is elicited. This patient's concerns about what might be wrong with him and the potential consequences of the therapies that might be necessary caused him considerable concern. Focused questions regarding illness anxiety revealed these issues.
Overall efficiency of evaluation is improved, providing more time for important issues. Screening questions were pursued that eliminated numerous other potential problems, such as use of NSAIDs or aspirin in patients with acid peptic disease, thereby allowing the clinician and patient to focus on the major problems.
Dynamic problem lists are incorporated into the clinical pathway. Assigning ICD-9 codes allows CarePrep to generate a final problem list (required by Joint Commission on Accreditation of Health Care Organizations, JCAHO). More importantly, a dynamic problem list becomes an integral part of the evaluation and treatment process.
Accuracy and efficiency of reporting are facilitated. An encounter form necessary for billing and justification of time allocations is generated as a direct reflection of an accurate problem list. This output includes both diagnostic codes and treatment interventions. Time allocated to the encounter is recorded from the initial check-in of the patient to the clinician signature on the final report.

1. A data processing system comprising:
one or more computer processors programmed to receive health information from a patient using software operable to pose a series of logic-driven exploratory questions to identify and prioritize said patient's major complaints;
wherein said exploratory questions ask about groups of related items;
wherein said exploratory questions determine a time frame of relevance to said patient and said patient's judgment of relevance of a symptom, wherein said relevance is characterized by one or more of: patient's priority for discussion with a clinician, severity of said symptom, and magnitude of problems or impact on quality of life resulting from said symptom;
wherein said software is further operable to construct subsequent, more detailed questions from a database of potential questions, based upon said patient's responses to said exploratory questions;
wherein said software is further operable to match said patient to a pre-selected interview configuration profile from a family of such profiles that determine inquiry scope and inquiry depth of a given patient interview, said inquiry scope specifying a set of interview topics to be covered, and said inquiry depth specifying a level of detail for a characterization of elicited symptoms; and
wherein said software is further operable to dynamically integrate input from multiple sources to determine a depth of detailed questioning to pursue, said sources for providing data regarding relevance to patient, desired depth of characterization detail for a topic as determined by a configuration profile, or medical importance of a given topic as determined by experts.
